(19) United States
(12) Patent Application Publication
(10) Pub. No.: US 2026/0285556 A1
(43) Pub. Date: Sep. 24, 2026

(54) BIOPOLYMER CONTAINMENTS WITH COATINGS

(71) Applicant: Double Double D, LLC, Raleigh, NC (US)

(72) Inventors: Daniel Doster, Raleigh, NC (US); Michael DeBrosse, Pineville, OR (US); Sreeju Puthenparambil Vasudevan, Kerala (IN)

(21) Appl. No.: 19/571,226

(22) Filed: Mar. 18, 2026

Related U.S. Application Data
(60) Provisional application No. 63/773,820, filed on Mar. 18, 2025.
(60) Provisional application No. 63/831,642, filed on Jun. 27, 2025.

(51) Int. Cl. B65D 51/00; B65D 65/42; C08K 3/36; C08K 5/17; C08L 67/04; C09D 7/63; C09D 167/04; C09D 191/06

(52) U.S. Cl. CPC B65D 51/005; B65D 65/42; C08K 3/36; C08K 5/17; C08L 67/04; C09D 7/63; C09D 167/04; C09D 191/06; C08L 2205/025

(57) ABSTRACT

The present disclosure concerns containments that are biodegradable. In some aspects, the containments include a biopolymer layer that includes one or more polymeric compounds and a coating layer. In some aspects the biopolymer layer includes PLA and PHA. In some aspects the coating layer includes at least one of polycaprolactone (PCL), alkyl ketene dimer (AKD), poly(vinyl) alcohol (PVA), citric acid, polydimethylsiloxane (PDMS), beeswax, carnauba wax, and montmorillonite (MMT) nanoclay.

### CROSS-REFERENCE TO RELATED APPLICATIONS

This application claims priority to U.S. Provisional Patent Application 63/773,820, filed Mar. 18, 2025 and U.S. Provisional Patent Application 63/831,642, filed Jun. 27, 2025, the content of which are hereby incorporated by reference in their entirety.

### BACKGROUND

Plastic bottles and plastic containers in general are popular due to the convenience and disposability, yet they consume landfill space at an alarming rate, requiring years to degrade if at all. Many plastics are not recyclable or they are not properly recycled, never reaching a recycling center. The capability to degrade naturally offers a solution that removes responsibility from a consumer and alleviates landfill space. Businesses that deal in disposable packaging, such as beverages and pharmaceuticals, would find it advantageous to use ecologically safe containments not only because of the ecological benefits in reusing and ecologically degrading materials, but because it would reinforce their public esteem. As such, a need exists in the industry for improved features for an ecologically safe containment.

### SUMMARY

In a first aspect, the disclosure provided a containment. The containment comprises a biopolymer layer comprised of a biopolymer, wherein the biopolymer includes at least one of polyhydroxyalkanote (PHA), poly(3-hydroxybutyrate-co-3-hydroxyvalerate) (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof, and a coating layer disposed on one or more surfaces of the biopolymer layer, the coating layer comprising at least one of silica nanoparticles, hydrophobic silica nanoparticles, bees wax, soya wax, cellulose, cellulose acetate, cellulose triacetate, carboxy methyl cellulose, montmorillonite (MMT), alkyl ketene dimer (AKD), AKD nanoparticles, AKD wax, poly(vinyl) alcohol (PVA), carnauba wax, palmityl chloride, polyvinyl palmitate chloride (PVPC), starch (soluble), starch nanoparticles, xylan, tapioca, palm root, tetraethyl orthosilicate (TEOS), zein, zein nanoparticles, glycerol, gelatin, sorbitol, ammonium zirconium carbonate (AZC), ethylene-vinyl alcohol copolymer (EVOH), polyhydroxy alkanotes (PHA), polydimethylsiloxane (PDMS), gelatin, sodium acetate, lignin, zinc oxide nanoparticles, copper (II) oxide nanoparticles, copper (I) oxide nanoparticles, magnesium oxide nanoparticles, nano clay nanoparticles, nano-starch nanoparticles, nano-cellulose nanoparticles, carbon nanotubes nanoparticles, carbon nanotube fiber nanoparticles, stearic acid, citric acid, glycerol, starch, HNTs, PDMS, soybean oil, zein, chitosan, nano clay, cellulose nanofibers, cellulose ester(s), PLA, and/or PCL and/or titanium dioxide nanoparticles.

In a second aspect, the disclosure provides the containment of the first aspect, in which the biopolymer layer comprises at least one of polyhydroxyalkanote (PHA), poly(3-hydroxybutyrate-co-3-hydroxyvalerate) (PHBV), polybutylene succinate (PBS), polylactic acid (PLA), polybutylene adipate terephthalate (PBAT), and PBSA (polybutylene succinate-co-butylene adipate).

In a third aspect, the disclosure provides the containment of the first or second aspect, in which the biopolymer layer comprises PLA and PHA.

In a fourth aspect, the disclosure provides the containment of any of the first through third aspects, in which the biopolymer layer comprises 20 to 80% by weight PLA and 20 to 80% by weight PHA.

In a fifth aspect, the disclosure provides the containment of any of the first through fourth aspects, in which the biopolymer layer further comprises one or more additives at up to 10% by weight of the biopolymer layer, the additives elected from one or more of a blowing additive, an antioxidant, an ethylene copolymer, an aliphatic-aromatic copolyester, a compactable additive, antioxidant, and a mold release agent.

In a sixth aspect, the disclosure provides the containment of the fifth aspect, in which the additives include one or more of erucamide and silica.

In a seventh aspect, the disclosure provides the containment of fifth or sixth aspect, in which the biopolymer layer comprises 45 to 55 wt % PLA, 40 to 50 wt % PHA, and 3 to 10 wt % additives, preferably 48 to 52 wt % PLA, 43 to 47 wt % PHA, and 4 to 6 wt % additives.

In an eighth aspect, the disclosure provides the containment of any of the first through seventh aspects, in which the coating layer comprises at least one of polycaprolactone (PCL), alkyl ketene dimer (AKD), AKD nanoparticles, AKD wax, poly(vinyl) alcohol (PVA), polydimethylsiloxane (PDMS), beeswax, carnauba wax, citric acid, and montmorillonite (MMT) nanoclay.

In a ninth aspect, the disclosure provides the containment of any of the first through eighth aspects, in which the coating layer comprises a first layer and a second layer, wherein the first layer is applied to the biopolymer layer and the second layer is applied to the first layer.

In a tenth aspect, the disclosure provides the containment of the ninth aspect, in which the first layer comprises 40 to 50 wt % PCL, 40 to 50 wt % AKD, and 5 to 15 wt % citric acid.

In an eleventh aspect, the disclosure provides the containment of the tenth aspect, in which the second layer comprises 85 to 95 wt % PCL and 5 to 15 wt % citric acid.

In a twelfth aspect, the disclosure provides the containment of the ninth aspect, in which the first layer comprises 13 to 24 wt % beeswax, 28 to 38 wt % carnauba wax, 32 to 42 wt % PCL, and 6 to 16 wt % citric acid, preferably 15 to 22 wt % beeswax, 28 to 38 wt % carnauba wax, 32 to 42 wt % PCL, and 8 to 14 wt % citric acid.

In a thirteenth aspect, the disclosure provides the containment of the twelfth aspect, in which the second layer comprises 85 to 95 wt % PCL and 5 to 15 wt % citric acid.

In a fourteenth aspect, the disclosure provides the containment of any of the first through eighth aspects, in which the coating layer comprises 45 to 56 wt % PCL, 35 to 45 wt % AKD, and 4 to 14 wt % citric acid, preferably 48 to 54 wt % PCL, 38 to 44 wt % AKD, and 6 to 12 wt % citric acid.

In a fifteenth aspect, the disclosure provides the containment of any of the first through eighth aspects, in which the coating layer comprises 45 to 55 wt % PCL, 35 to 45 wt % AKD wax, and 5 to 15 wt % citric acid, preferably 49 to 51 wt % PCL, 39 to 41 wt % AKD wax, and 9 to 11 wt % citric acid.

In a sixteenth aspect, the disclosure provides the containment of any of the first through eighth aspects, in which the coating layer comprises 11 to 21 wt % beeswax, 24 to 34 wt % carnauba wax, 40 to 50 wt % PCL, and 6 to 16 wt. % citric acid, preferably 14 to 18 wt % beeswax, 26 to 32 wt % carnauba wax, 42 to 48 wt % PCL, and 8 to 14 wt. % citric acid.

In a seventeenth aspect, the disclosure provides the containment of any of the first through eighth aspects, in which the coating layer comprises 14 to 24 wt % PVA, 3 to 11 wt % MMT, 29 to 39 wt % ADK wax emulsion, 29 to 39 wt % carnauba wax emulsion, and 2 to 8 wt % PDMS, preferably 17 to 20 wt % PVA, 6 to 8 wt % MMT, 33 to 36 wt % ADK wax emulsion, 33 to 36 wt % carnauba wax emulsion, and 3 to 6 wt % PDMS.

In an eighteenth aspect, the disclosure provides the containment of any of the first through eighth aspects, in which the coating layer comprises 15 to 25 wt % PVA, 3 to 11 wt % MMT, 31 to 41 wt % ADK wax emulsion, and 31 to 41 wt % carnauba wax emulsion, preferably 18 to 21 wt % PVA, 6 to 8 wt % MMT, 35 to 38 wt % ADK wax emulsion, and 35 to 38 wt % carnauba wax emulsion.

In a nineteenth aspect, the disclosure provides the containment of any of the first through eighteenth aspects, in which the containment further comprises a cap comprising the biopolymer.

In a twentieth aspect, the disclosure provides the containment of the nineteenth aspect, in which the cap further comprises the coating layer.

### DESCRIPTION

The present disclosure concerns biodegradable containments, wherein each component and/or material will degrade over time. In some aspects, the containment may contain at least a biopolymer layer and a coating layer. Specifically, a containment formed from a biopolymer to provide biodegradability to the containment may additionally include a coating layer to enhance one or more attributes of the formed containment.

### Biopolymer

In some aspects, the containments of the present disclosure may include a biopolymer layer.

Biopolymers or biopolymer composites of two or more biopolymers are formed by cross-linking monomeric units. Cross-linking can occur through chemical and/or physical processes, such as by providing an initiator, a crosslinking agent, UV radiation, heat, light, agitation, and so forth. In some aspects, a biopolymer composite is formed through combining two or more monomers and initiating cross-linking thereof. As used herein, “biopolymer” accordingly refers to polymers of both cross-linked monomers and cross-linked composites of two or more monomers. In some aspects, a biopolymer refers to a cross-linked polymer of at least one of polyhydroxyalkanote (PHA), poly(3-hydroxybutyrate-co-3-hydroxyvalerate) (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), poly(propylene carbonate-co-phthalate) (PPC-P), chitosan, polycaprolactone (PCL), and combinations thereof.

PLA (Polylactic Acid) is a biopolymer with high biocompatibility, biodegradability, and thermal plasticity. However, its rigidity and brittleness limit its application in certain packaging sectors. PHA (polyhydroxyalkanoate) is another biopolymer having increased flexibility and biodegradability. By combining PLA and PHA in an optimized formulation with various processing additives, the present disclosure overcomes the shortcomings of individual biopolymers and provides a solution with improved mechanical properties while maintaining biodegradability.

In some aspects, the biopolymer is of a single compound or a composite of two or more polymeric compounds. In some aspects, the polymeric compound is one or more of polyhydroxyalkanoate (PHA), a PHA-type polymer, such as poly(3-hydroxybutyrate-co-3-hydroxyvalerate) (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), poly(propylene carbonate-co-phthalate) (PPC-P), chitosan, polycaprolactone (PCL), and combinations thereof. In some aspects, the biopolymer may include a cofactor. A cofactor may include a material as described herein. In some aspects, the biopolymer may include one or more of carbon nanofibers (CNF), silicon dioxide nanoparticles, copper oxide nanoparticles (including CuO and/or Cu₂O), titanium dioxide nanoparticles, magnesium oxide nanoparticles, nano clays (nano-layered silicates), and/or chitosan.

It is expressly noted that, as PHBV is a subset of PHA, all references to PHA throughout the present disclosure also are intended to include a similar express disclosure to PHBV. Specifically, PHA (polyhydroxyalkanoates) is a broader category of biodegradable polyesters, while PHBV (poly(3-hydroxybutyrate-co-3-hydroxyvalerate) is a specific type of PHA that includes valerate as a comonomer, enhancing its flexibility and processing properties.

It is expressly noted that, as nano silica and silica nanoparticles are a subset of silica, all references to silica throughout the present disclosure also are intended to include a similar express disclosure to nano silica and silica nanoparticles. Specifically, silica is a broader category, while nano silica and silica nanoparticles references silica particles having about 1 to about 100 nm in diameter or cross-sectional width. Throughout the disclosure, reference to one is also intended to reference the others.

In some aspects, the biopolymer is of a single polymeric compound, such as 100% PBS, 100% PHA, 100% PHBV, 100% lignin, 100% PLA, 100% PHB, 100% PBAT, 100% PBSA, 100% PCL, 100% PGA, 100% PHBH, 100% PBST, 100% PPC-P, or other biopolymer. In other aspects, the biopolymer is a composite of two or more polymeric compounds. It will be appreciated that variance in the amount of polymeric compound can in turn provide different qualities to the resulting biopolymer. In some aspects, the biopolymer may be of from about 10 to about 90±10% wt % PHA, including about 0, 5, 10, 15, 20, 25, 30, 35, 40, 45, 50, 55, 60, 65, 70, 75, 80, 85, 90, 95, and 100 wt % PHA. In some aspects, the biopolymer may be of from about 10 to about 90 wt %±10% PBS, including about 0, 5, 10, 15, 20, 25, 30, 35, 40, 45, 50, 55, 60, 65, 70, 75, 80, 85, 90, 95, and 100 wt % PBS. In some aspects, the biopolymer may be of from about 10 to about 90 wt %±10% lignin, including about 0, 5, 10, 15, 20, 25, 30, 35, 40, 45, 50, 55, 60, 65, 70, 75, 80, 85, 90, 95, and 100 wt % lignin. In some aspects, the biopolymer may be of from about 10 to about 90 wt %±10% PLA, including about 0, 5, 10, 15, 20, 25, 30, 35, 40, 45, 50, 55, 60, 65, 70, 75, 80, 85, 90, 95, and 100 wt % PLA. In some aspects, the biopolymer may be of from about 10 to about 90 wt %±10% PHBV, including about 0, 5, 10, 15, 20, 25, 30, 35, 40, 45, 50, 55, 60, 65, 70, 75, 80, 85, 90, 95, and 100 wt % PHBV. In some aspects, the biopolymer may be of from about 10 to about 90±10% wt % PPC-P, including about 0, 5, 10, 15, 20, 25, 30, 35, 40, 45, 50, 55, 60, 65, 70, 75, 80, 85, 90, 95, and 100 wt % PPC-P. In some aspects, the biopolymer may be of from about 10 to about 90±10% wt % PBAT, including about 0, 5, 10, 15, 20, 25, 30, 35, 40, 45, 50, 55, 60, 65, 70, 75, 80, 85, 90, 95, and 100 wt % PBAT.

In some aspects, the biopolymer may be a composite to about 20 to about 80 wt %±10% PLA with about 20 to about 80 wt %±10% PHA. In some aspects, the biopolymer may be a composite to about 20 to about 80 wt %±10% PLA with about 20 to about 80 wt %±10% PBS. In some aspects, the biopolymer may be a composite to about 20 to about 80 wt %±10% PLA with about 20 to about 80 wt %±10% PHBV. In some aspects, the biopolymer may be a composite to about 20 to about 80 wt %±10% PLA with about 20 to about 80 wt %±10% PBAT. In some aspects, the biopolymer may be a composite to about 20 to about 80 wt %±10% PLA with about 20 to about 80 wt %±10% PPC-P.

In some aspects, the biopolymer may be a composite of about 90 wt %±10% PLA with about 10 wt %±10% PHA/PHBV/PBAT/PBS/PPC-P. In some aspects, the biopolymer may be a composite of about 85 wt %±10% PLA with about 15 wt %±10% PHA/PHBV/PBAT/PBS/PPC-P. In some aspects, the biopolymer may be a composite of about 80 wt %±10% PLA with about 20 wt %±10% PHA/PHBV/PBAT/PBS/PPC-P. In some aspects, the biopolymer may be a composite of about 75 wt %±10% PLA with about 25 wt %±10% PHA/PHBV/PBAT/PBS/PPC-P. In some aspects, the biopolymer may be a composite of about 70 wt %±10% PLA with about 30 wt %±10% PHA/PHBV/PBAT/PBS/PPC-P. In some aspects, the biopolymer may be a composite of about 65 wt %±10% PLA with about 35 wt %±10% PHA/PHBV/PBAT/PBS/PPC-P. In some aspects, the biopolymer may be a composite of about 60 wt %±10% PLA with about 40 wt %±10% PHA/PHBV/PBAT/PBS/PPC-P. In some aspects, the biopolymer may be a composite of about 55 wt %±10% PLA with about 45 wt %±10% PHA/PHBV/PBAT/PBS/PPC-P. In some aspects, the biopolymer may be a composite of about 50 wt %±10% PLA with about 50 wt %±10% PHA/PHBV/PBAT/PBS/PPC-P. In some aspects, the biopolymer may be a composite of about 45 wt %±10% PLA with about 55 wt %±10% PHA/PHBV/PBAT/PBS/PPC-P. In some aspects, the biopolymer may be a composite of about 40 wt %±10% PLA with about 60 wt %±10% PHA/PHBV/PBAT/PBS/PPC-P. In some aspects, the biopolymer may be a composite of about 35 wt %±10% PLA with about 65 wt %±10% PHA/PHBV/PBAT/PBS/PPC-P. In some aspects, the biopolymer may be a composite of about 30 wt %±10% PLA with about 70 wt %±10% PHA/PHBV/PBAT/PBS/PPC-P. In some aspects, the biopolymer may be a composite of about 25 wt %±10% PLA with about 75 wt %±10% PHA/PHBV/PBAT/PBS/PPC-P. In some aspects, the biopolymer may be a composite of about 20 wt %±10% PLA with about 80 wt %±10% PHA/PHBV/PBAT/PBS/PPC-P. In some aspects, the biopolymer may be a composite of about 15 wt %±10% PLA with about 85 wt %±10% PHA/PHBV/PBAT/PBS/PPC-P. In some aspects, the biopolymer may be a composite of about 10 wt %±10% PLA with about 90 wt %±10% PHA/PHBV/PBAT/PBS/PPC-P.

In some aspects, the biopolymer may be a composite of about 90 wt %±10% PLA with about 10 wt %±10% PHA. In some aspects, the biopolymer may be a composite of about 80 wt %±10% PLA with about 20 wt %±10% PHA. In some aspects, the biopolymer may be a composite of about 85 wt %±10% PLA with about 15 wt %±10% PHA. In some aspects, the biopolymer may be a composite to about 75 wt %±10% PLA with about 25 wt %±10% PHA. In some aspects, the biopolymer may be a composite of about 70 wt %±10% PLA with about 30 wt %±10% PHA. In some aspects, the biopolymer may be a composite of about 65 wt %±10% PLA with about 35 wt %±10% PHA. In some aspects, the biopolymer may be a composite of about 60 wt %±10% PLA with about 40 wt %±10% PHA. In some aspects, the biopolymer may be a composite of about 55 wt %±10% PLA with about 45 wt %±10% PHA. In some aspects, the biopolymer may be a composite of about 50 wt %±10% PLA with about 50 wt %±10% PHA. In some aspects, the biopolymer may be a composite of about 45 wt %±10% PLA with about 55 wt %±10% PHA. In some aspects, the biopolymer may be a composite of about 40 wt %±10% PLA with about 60 wt %±10% PHA. In some aspects, the biopolymer may be a composite of about 35 wt %±10% PLA with about 65 wt %±10% PHA. In some aspects, the biopolymer may be a composite of about 30 wt %±10% PLA with about 70 wt %±10% PHA. In some aspects, the biopolymer may be a composite of about 25 wt %±10% PLA with about 75 wt %±10% PHA. In some aspects, the biopolymer may be a composite of about 20 wt %±10% PLA with about 80 wt %±10% PHA. In some aspects, the biopolymer may be a composite of about 15 wt %±10% PLA with about 85 wt %±10% PHA. In some aspects, the biopolymer may be a composite of about 10 wt %±10% PLA with about 90 wt %±10% PHA.

In some aspects, the biopolymer may be a composite of about 90 wt %±10% PLA with about 10 wt %±10% PBS. In some aspects, the biopolymer may be a composite of about 80 wt %±10% PLA with about 20 wt %±10% PBS. In some aspects, the biopolymer may be a composite of about 85 wt %±10% PLA with about 15 wt %±10% PBS. In some aspects, the biopolymer may be a composite to about 75 wt %±10% PLA with about 25 wt %±10% PBS. In some aspects, the biopolymer may be a composite of about 70 wt %±10% PLA with about 30 wt %±10% PBS. In some aspects, the biopolymer may be a composite of about 65 wt %±10% PLA with about 35 wt %±10% PBS. In some aspects, the biopolymer may be a composite of about 60 wt %±10% PLA with about 40 wt %±10% PBS. In some aspects, the biopolymer may be a composite of about 55 wt %±10% PLA with about 45 wt %±10% PBS. In some aspects, the biopolymer may be a composite of about 50 wt %±10% PLA with about 50 wt %±10% PBS. In some aspects, the biopolymer may be a composite of about 45 wt %±10% PLA with about 55 wt %±10% PBS. In some aspects, the biopolymer may be a composite of about 40 wt %±10% PLA with about 60 wt %±10% PBS. In some aspects, the biopolymer may be a composite of about 35 wt %±10% PLA with about 65 wt %±10% PBS. In some aspects, the biopolymer may be a composite of about 30 wt %±10% PLA with about 70 wt %±10% PBS. In some aspects, the biopolymer may be a composite of about 25 wt %±10% PLA with about 75 wt %±10% PBS. In some aspects, the biopolymer may be a composite of about 20 wt %±10% PLA with about 80 wt %±10% PBS. In some aspects, the biopolymer may be a composite of about 15 wt %±10% PLA with about 85 wt %±10% PBS. In some aspects, the biopolymer may be a composite of about 10 wt %±10% PLA with about 90 wt %±10% PBS.

In some aspects, the biopolymer may be a composite of about 90 wt %±10% PLA with about 10 wt %±10% PBAT. In some aspects, the biopolymer may be a composite of about 80 wt %±10% PLA with about 20 wt %±10% PBAT. In some aspects, the biopolymer may be a composite of about 85 wt %±10% PLA with about 15 wt %±10% PBAT. In some aspects, the biopolymer may be a composite to about 75 wt %±10% PLA with about 25 wt %±10% PBAT. In some aspects, the biopolymer may be a composite of about 70 wt %±10% PLA with about 30 wt %±10% PBAT. In some aspects, the biopolymer may be a composite of about 65 wt %±10% PLA with about 35 wt %±10% PBAT. In some aspects, the biopolymer may be a composite of about 60 wt %±10% PLA with about 40 wt %±10% PBAT. In some aspects, the biopolymer may be a composite of about 55 wt %±10% PLA with about 45 wt %±10% PBAT. In some aspects, the biopolymer may be a composite of about 50 wt %±10% PLA with about 50 wt %±10% PBAT. In some aspects, the biopolymer may be a composite of about 45 wt %±10% PLA with about 55 wt %±10% PBAT. In some aspects, the biopolymer may be a composite of about 40 wt %±10% PLA with about 60 wt %±10% PBAT. In some aspects, the biopolymer may be a composite of about 35 wt %±10% PLA with about 65 wt %±10% PBAT. In some aspects, the biopolymer may be a composite of about 30 wt %±10% PLA with about 70 wt %±10% PBAT. In some aspects, the biopolymer may be a composite of about 25 wt %±10% PLA with about 75 wt %±10% PBAT. In some aspects, the biopolymer may be a composite of about 20 wt %±10% PLA with about 80 wt %±10% PBAT. In some aspects, the biopolymer may be a composite of about 15 wt %±10% PLA with about 85 wt %±10% PBAT. In some aspects, the biopolymer may be a composite of about 10 wt %±10% PLA with about 90 wt %±10% PBAT.

In some aspects, the biopolymer may be a composite of about 90 wt %±10% PLA with about 10 wt %±10% PPC-P. In some aspects, the biopolymer may be a composite of about 80 wt %±10% PLA with about 20 wt %±10% PPC-P. In some aspects, the biopolymer may be a composite of about 85 wt %±10% PLA with about 15 wt %±10% PPC-P. In some aspects, the biopolymer may be a composite to about 75 wt %±10% PLA with about 25 wt %±10% PPC-P. In some aspects, the biopolymer may be a composite of about 70 wt %±10% PLA with about 30 wt %±10% PPC-P. In some aspects, the biopolymer may be a composite of about 65 wt %±10% PLA with about 35 wt %±10% PPC-P. In some aspects, the biopolymer may be a composite of about 60 wt %±10% PLA with about 40 wt %±10% PPC-P. In some aspects, the biopolymer may be a composite of about 55 wt %±10% PLA with about 45 wt %±10% PPC-P. In some aspects, the biopolymer may be a composite of about 50 wt %±10% PLA with about 50 wt %±10% PPC-P. In some aspects, the biopolymer may be a composite of about 45 wt %±10% PLA with about 55 wt %±10% PPC-P. In some aspects, the biopolymer may be a composite of about 40 wt %±10% PLA with about 60 wt %±10% PPC-P. In some aspects, the biopolymer may be a composite of about 35 wt %±10% PLA with about 65 wt %±10% PPC-P. In some aspects, the biopolymer may be a composite of about 30 wt %±10% PLA with about 70 wt %±10% PPC-P. In some aspects, the biopolymer may be a composite of about 25 wt %±10% PLA with about 75 wt %±10% PPC-P. In some aspects, the biopolymer may be a composite of about 20 wt %±10% PLA with about 80 wt %±10% PPC-P. In some aspects, the biopolymer may be a composite of about 15 wt %±10% PLA with about 85 wt %±10% PPC-P. In some aspects, the biopolymer may be a composite of about 10 wt %±10% PLA with about 90 wt %±10% PPC-P.

In some aspects, the biopolymer may be a composite of about 90 wt %±10% PLA with about 10 wt %±10% PHBV. In some aspects, the biopolymer may be a composite of about 80 wt %±10% PLA with about 20 wt %±10% PHBV. In some aspects, the biopolymer may be a composite of about 85 wt %±10% PLA with about 15 wt %±10% PHBV. In some aspects, the biopolymer may be a composite to about 75 wt %±10% PLA with about 25 wt %±10% PHBV. In some aspects, the biopolymer may be a composite of about 70 wt %±10% PLA with about 30 wt %±10% PHBV. In some aspects, the biopolymer may be a composite of about 65 wt %±10% PLA with about 35 wt %±10% PHBV. In some aspects, the biopolymer may be a composite of about 60 wt %±10% PLA with about 40 wt %±10% PHBV. In some aspects, the biopolymer may be a composite of about 55 wt %±10% PLA with about 45 wt %±10% PHBV. In some aspects, the biopolymer may be a composite of about 50 wt %±10% PLA with about 50 wt %±10% PHBV. In some aspects, the biopolymer may be a composite of about 45 wt %±10% PLA with about 55 wt %±10% PHBV. In some aspects, the biopolymer may be a composite of about 40 wt %±10% PLA with about 60 wt %±10% PHBV. In some aspects, the biopolymer may be a composite of about 35 wt %±10% PLA with about 65 wt %±10% PHBV. In some aspects, the biopolymer may be a composite of about 30 wt %±10% PLA with about 70 wt %±10% PHBV. In some aspects, the biopolymer may be a composite of about 25 wt %±10% PLA with about 75 wt %±10% PHBV. In some aspects, the biopolymer may be a composite of about 20 wt %±10% PLA with about 80 wt %±10% PHBV. In some aspects, the biopolymer may be a composite of about 15 wt %±10% PLA with about 85 wt %±10% PHBV. In some aspects, the biopolymer may be a composite of about 10 wt %±10% PLA with about 90 wt %±10% PHBV.

In some aspects, the biopolymers may include up to 10% additional materials, such as an antioxidant and/or an ethylene copolymer and/or erucamide and/or nano silica. The additional materials replace a portion of the PLA and/or PHA/PHBV/PBAT/PBS/PPC-P in each of the previously disclosed formulations. For example, the biopolymer may include 50% PLA, 45% PHA, 2% erucamide, and 3% nano silica. For conciseness, each of such additional combinations are not expressly provided, but are equally envisioned as part of the present disclosure.

In some aspects, the biopolymer may be of polyhydroxyalkanote (PHA) or a composite including PHA. In some aspects, the biopolymer may be of about 0 to about 95 wt % PHA, including about 5, 10, 15, 20, 25, 30, 35, 40, 45, 50, 55, 60, 65, 70, 75, 80, 85, and 90 wt %. In some aspects, PHA may be included with PLA, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1. In some aspects, the biopolymer may be a composite of about 5 to about 95 wt % PHA and/or PHBV/PPC-P/PBS/PBAT, with about 5 to about 95 wt % PLA. In some aspects, the biopolymer may be a composite of about 5 to about 70 wt % PHA and/or PHBV/PPC-P/PBS/PBAT, with about 30 to about 95 wt % PLA. In some aspects, the biopolymer may be a composite of about 10 to about 70 wt % PHA and/or PHBV/PPC-P/PBS/PBAT, with about 30 to about 90 wt % PLA.

In some aspects, the biopolymer may be of polybutylene adipate terephthalate (PBAT) or a composite including PBAT. In some aspects, the biopolymer may be of about 0 to about 95 wt % PBAT, including about 5, 10, 15, 20, 25, 30, 35, 40, 45, 50, 55, 60, 65, 70, 75, 80, 85, and 90 wt %. In some aspects, PBAT may be included with PLA, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1. In some aspects, the biopolymer may be a composite of about 5 to about 95 wt % PBAT and/or PHA/PHBV/PPC-P/PBS, with about 5 to about 95 wt % PLA. In some aspects, the biopolymer may be a composite of about 5 to about 70 wt % PBAT and/or PHA/PHBV/PPC-P/PBS, with about 30 to about 95 wt % PLA. In some aspects, the biopolymer may be a composite of about 10 to about 70 wt % PBAT and/or PHA/PHBV/PPC-P/PBS, with about 30 to about 90 wt % PLA.

In some aspects, the biopolymer may be of PBS or a composite including PBS. In some aspects, the biopolymer may be of about 0 to about 95 wt % PBS, including about 5, 10, 15, 20, 25, 30, 35, 40, 45, 50, 55, 60, 65, 70, 75, 80, 85, and 90 wt %. In some aspects, PBS may be included with PLA, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1. In some aspects, the biopolymer may be a composite of about 5 to about 95 wt % PBS and/or PHA/PHBV/PPC-P/PBAT, with about 5 to about 95 wt % PLA. In some aspects, the biopolymer may be a composite of about 5 to about 70 wt % PBS and/or PHA/PHBV/PPC-P/PBAT, with about 30 to about 95 wt % PLA. In some aspects, the biopolymer may be a composite of about 10 to about 70 wt % PBS and/or PHA/PHBV/PPC-P/PBAT, with about 30 to about 90 wt % PLA.

In some aspects, the biopolymer may be of PHBV or a composite including PHBV. In some aspects, the biopolymer may be of about 0 to about 95 wt % PHBV, including about 5, 10, 15, 20, 25, 30, 35, 40, 45, 50, 55, 60, 65, 70, 75, 80, 85, and 90 wt %. In some aspects, PHBV may be included with PLA, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1. In some aspects, the biopolymer may be a composite of about 5 to about 95 wt % PHBV and/or PHA/PBS/PPC-P/PBAT, with about 5 to about 95 wt % PLA. In some aspects, the biopolymer may be a composite of about 5 to about 70 wt % PHBV and/or PHA/PBS/PPC-P/PBAT, with about 30 to about 95 wt % PLA. In some aspects, the biopolymer may be a composite of about 10 to about 70 wt % PHBV and/or PHA/PBS/PPC-P/PBAT, with about 30 to about 90 wt % PLA.

In some aspects, the biopolymer may be of PPC-P or a composite including PPC-P. In some aspects, the biopolymer may be of about 0 to about 95 wt % PPC-P, including about 5, 10, 15, 20, 25, 30, 35, 40, 45, 50, 55, 60, 65, 70, 75, 80, 85, and 90 wt %. In some aspects, PPC-P may be included with PLA, such as at a ratio of about 1:1, 1:2, 1:3, 1:4, 1:5, 1:6, 1:7, 1:8, 1:9 and 1:10, or at a ratio of about 2:1, 3:1, 4:1, 5:1, 6:1, 7:1, 8:1, 9:1, or 10:1. In some aspects, the biopolymer may be a composite of about 5 to about 95 wt % PPC-P and/or PHA/PBS/PHBV/PBAT, with about 5 to about 95 wt % PLA. In some aspects, the biopolymer may be a composite of about 5 to about 70 wt % PPC-P and/or PHA/PBS/PHBV/PBAT, with about 30 to about 95 wt % PLA. In some aspects, the biopolymer may be a composite of about 10 to about 70 wt % PPC-P and/or PHA/PBS/PHBV/PBAT, with about 30 to about 90 wt % PLA.

In some aspects, the biopolymer includes a further agent or cofactor or additive. Such may include one or more of a blowing additive, an antioxidant, an ethylene copolymer, an aliphatic-aromatic copolyester, a compactable additive, antioxidant, and a mold release agent. In some aspects, the biopolymer may be a composite of biopolymer(s) and about 0.1 to about 10% blowing additive, antioxidant, ethylene copolymer, and/or mold release agent. In some aspects, the composite may be of about 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.5, 2.6, 2.7, 2.8, 2.9, 3.0, 3.1, 3.2, 3.3, 3.4, 3.5, 3.6, 3.7, 3.8, 3.9, 44.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, and 9.9 wt % blowing additive, antioxidant, ethylene copolymer, aliphatic-aromatic copolyester, and/or mold release agent.

In some aspects, a blowing additive may include melt phase and solid state processing aids such as IncroMax™ and/or Atmer™ (Cargill, Minneapolis, MN). Antioxidants can include oxygen and/or reactive oxygen species scavengers and are understood in the industry. Aliphatic-aromatic copolyesters are also understood and include polymer chains of 1,4 butanediol, adipic acid, and terephathalic acid, such as Ecoflex® F Blend C1200 (BASF, Ludwigshafen, Germany). Ethylene copolymers are understood, such as DuPont™ Biomax® EP9000A. Mold release agents are understood and can include agents that deliver silicone or wax or similar to a mold surface, such as a mineral oil, xylene, DMSO (dimethyl sulfoxide), THF (tetrahydrofuran), acetone, toluene, or other organic solvent as well as slip and anti-clocking additives such as erucamide (C₂₂H₄₃NO, cis-13-docosenamide).

In some aspects, the biopolymer layer may include an antioxidant. The antioxidant additive is a chemical stabilizer specifically selected to prevent the degradation of the biopolymer blend caused by exposure to oxygen during storage and processing. The antioxidant additive inhibits the oxidative degradation of biopolymers such as PLA and PHBV, extending the shelf life of the bottle and ensuring that it retains its mechanical properties over time. The antioxidant helps to maintain thermal stability during processing, preventing premature degradation during the high-temperature phases of injection stretch blow molding.

In some aspects, the biopolymer layer may include a compatibilizer, such as maleic anhydride grafted PLA or other suitable compatibilizers. The compatibilizer functions as a molecular bridge, improving the interfacial adhesion between biopolymers, thereby enhancing the mechanical and thermal properties of the blend.

In some aspects, the biopolymer layer is of 65 wt % PLA and 35 wt % PHA±10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is of 60 wt % PLA and 40 wt % PHA±10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is of 55 wt % PLA and 45 wt % PHA±10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is of 50 wt % PLA and 50 wt % PHA±10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is of 50 wt % PLA, 45 wt % PHA, and 5 wt % of a blow molding additive. In some aspects, the blow molding additive comprises, at least in part, erucamide. In some aspects, the blow molding additive comprises, at least in part, silica. In some aspects, the biopolymer layer is of 50 wt % PLA, 45 wt % PHA, 2 wt % erucamide, and 3 wt % nano silica.

In some aspects, the biopolymer layer is of 45 wt % PLA and 55 wt % PHA±10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is of 40 wt % PLA and 60 wt % PHA±10 wt % with up to 10 wt % of a blow molding additive. In some aspects, the blow molding additive comprises, at least in part, erucamide. In some aspects, the blow molding additive comprises, at least in part, silica.

In some aspects the biopolymer layer is of 35 wt % PLA and 65 wt % PHA 10 wt % with up to 10 wt % of a blow molding additive. In some aspects, the blow molding additive comprises, at least in part, erucamide. In some aspects, the blow molding additive comprises, at least in part, silica.

In some aspects, the biopolymer layer is a composite of one or more biopolymers and one or more materials. In some aspects, the composite may be of PLA and PHA and/or PHB and/or PHBH and carbon nanofibers to provide a fully bio-based and biodegradable nano composite, with high modulus and large aspect ratio, good thermal stability, and enhanced water vapor/oxygen barrier property. In some aspects, the composite may be of PLA and PHA and/or PHB and/or PHBH and silicon dioxide nanoparticles for good water vapor/oxygen barrier properties. In some aspects, the composite may be of PLA and PHA and/or PHB and/or PHBH and CuO and/or Cu₂O nanoparticles to provide antibacterial and/or antifungal properties, as well as good thermal stability and good gas/vapor barrier properties. In some aspects, the composite may be of PLA and PHA and/or PHB and/or PHBH and TiO₂ to provide decreased water vapor permeability, increased tensile strength, improved barrier property and antibacterial activity. In some aspects, the composite may be of PLA and PHA and/or PHB and/or PHBH and ZnO nanoparticles to provide improve shelf life and reduce WvTR (water vapor transmission rate) and OTR (oxygen transmission rate). In some aspects, the composite may be of PLA and PHA and/or PHB and/or PHBH and MgO nanoparticles to provide improved oxygen and water vapor barrier properties, anti-bacterial and anti-fungal properties, good tensile strength, and plasticity. In some aspects, the composite may be of PLA and PHA and/or PHB and/or PHBH and nano clays to provide antimicrobial activity and good barrier properties. In some aspects, the composite may be of PLA and PHA and/or PHB and/or PHBH and chitosan to provide good barrier properties.

### CAPS

In some aspects, the present disclosure may include a lid or cap for a containment. In some aspects, the lid or cap may be constructed of the same or a similar material as the body of the containment.

In some aspects, a cap may include an internal thread to allow for the cap to screw on to an external thread at the opening of the containment. For example, the body of the containment may comprise an external thread for a cap to be secured thereto.

In some aspects, the cap is of a biopolymer or contains a layer thereof therein. In some aspects, the cap may be of a biopolymer as set forth herein. In some aspects, the cap is made of PHA, such as 100 wt % PHA. In some aspects, the cap is made of PBS, such as 100 wt % PBS. In some aspects, the cap is made of PBAT, such as 100 wt % PBAT. In some aspects, the cap is made of PLA and PHA, such as 90 wt % PLA and 10 wt % PHA, 80 wt % PLA and 20 wt % PHA, 70 wt % PLA and 30 wt % PHA, 60 wt % PLA and 40 wt % PHA, and 50 wt % PLA and 50 wt % PHA. In some aspects, the cap is made of PLA and PBS, such as 90 wt % PLA and 10 wt % PBS, 80 wt % PLA and 20 wt % PBS, 70 wt % PLA and 30 wt % PBS, 60 wt % PLA and 40 wt % PBS, and 50 wt % PLA and 50 wt % PBS. In some aspects, the cap is made of PLA and PBAT, such as 90 wt % PLA and 10 wt % PBAT, 80 wt % PLA and 20 wt % PBAT, 70 wt % PLA and 30 wt % PBAT, 60 wt % PLA and 40 wt % PBAT, and 50 wt % PLA and 50 wt % PBAT. In some aspects, the cap is made of PLA and PHA, such as 90 wt % PLA and 10 wt % PHBV, 80 wt % PLA and 20 wt % PHBV, 70 wt % PLA and 30 wt % PHBV, 65 wt % PLA and 35 wt % PHBV, 60 wt % PLA and 40 wt % PHBV, and 50 wt % PLA and 50 wt % PHBV.

In some aspects, the biopolymer forming the cap is a composite of about 90 wt % PLA and about 10 wt % PHA and/or PHB and/or PHBH; about 85 wt % PLA and about 15 wt % PHA and/or PHB and/or PHBH; about 80 wt % PLA and about 20 wt % PHA and/or PHB and/or PHBH; about 75 wt % PLA and about 25 wt % PHA and/or PHB and/or PHBH; about 70 wt % PLA and about 30 wt % PHA and/or PHB and/or PHBH; about 65 wt % PLA and about 35 wt % PHA and/or PHB and/or PHBH; about 60 wt % PLA and about 40 wt % PHA and/or PHB and/or PHBH; about 55 wt % PLA and about 45 wt % PHA and/or PHB and/or PHBH; about 50 wt % PLA and about 50 wt % PHA and/or PHB and/or PHBH; about 45 wt % PLA and about 55 wt % PHA and/or PHB and/or PHBH; about 40 wt % PLA and about 60 wt % PHA and/or PHB and/or PHBH; about 35 wt % PLA and about 65 wt % PHA and/or PHB and/or PHBH; about 30 wt % PLA and about 70 wt % PHA and/or PHB and/or PHBH; about 25 wt % PLA and about 75 wt % PHA and/or PHB and/or PHBH; about 20 wt % PLA and about 80 wt % PHA and/or PHB and/or PHBH; about 15 wt % PLA and about 85 wt % PHA and/or PHB and/or PHBH; or, about 10 wt % PLA and about 90 wt % PHA and/or PHB and/or PHBH.

In some aspects, the cap may include up to 10 wt % additional materials, such as an antioxidant and/or an ethylene copolymer and/or erucamide and/or nano silica. The additional materials replace a portion of the PLA, PHA, PBS, PHBV, and/or PBAT in each of the previously disclosed formulations. For example, the cap may include 60 wt % PLA, 35 wt % PHA, 2 wt % erucamide, and 3 wt % nano silica or 50 wt % PLA, 45 wt % PHA, 2 wt % erucamide, and 3 wt % nano silica.

In some aspects, the biopolymer forming the cap is of 50 wt % PLA, 45 wt % PHA, and 5 wt % additional materials. In some aspects, the biopolymer forming the cap is of 50 wt % PLA, 45 wt % PHA, 2 wt % erucamide, and 3 wt % nano silica.

It will be appreciated that the cap may include and/or be coated with one or more of the materials as described herein, including the composites and parts thereof the coating material layer.

### Coating Material Layer

The coating layer may be provided in the containment as a layer, such as an external layer, an internal layer, and/or an intermediate layer. A coating layer may be affixed to the various biopolymer layers as described herein.

The materials or components of the coating layer may be of a hydrophobic material, a hydrophilic material, or a combination thereof. In some aspects, the materials may include a composite or nanocomposite of two or more materials. The coating layer may include a biopolymer, such as polycaprolactone (PCL), polyhydroxyalkanote (PHA), poly(3-hydroxybutyrate-co-3-hydroxyvalerate (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), poly(propylene carbonate-co-phthalate) (PPC-P), or chitosan.

The coating layer may additionally include silicon dioxide (silica) nanoparticles (NPs), zinc oxide NPs, copper oxide (including copper (II) oxide (cupric oxide or CuO) and/or copper (I) oxide (Cu₂O)), magnesium oxide, nano clay, nano-starch, wax, wax emulsions, beeswax, carnauba wax, carnauba wax emulsion, soya wax, nano-cellulose, cellulose acetate, cellulose, carboxy methyl cellulose, montmorillonite (MMT), hydrophobic silica (or superhydrophobic silica), polydimethylsiloxane, alkyl ketene dimer (AKD), AKD wax, AKD wax emulsion, AKD NPs, polyvinyl alcohol (PVA), polyvinyl palmitate chloride (PVPC), polydimethylsiloxane (PDMS), starch (e.g. corn starch, cassava starch, yam starch, palm sago starch, palm root), soluble starch, starch nanoparticles, montmorillonite (MMT) nanoclay, ammonium zirconium carbonate (AZC), lignin, bTPU, PCL, glycerol, tapioca, tetraethyl orthosilicate (TEOS), erucamide, gelatin, xylan, polyhydroxy alkanotes (PHA), ethylene-vinyl alcohol copolymer (EVOH), zein, zein NPs, sorbitol, sodium acetate, chloroform, sorbitol, carbon nanotubes and/or carbon nanotube fibers, and/or titanium dioxide, and combinations thereof.

Further, to assist in application of the coating layer, the coating layer may additionally include one or more solvents including water, chloroform, ethanol, acetone, isopropyl alcohol, toluene, hexane, and other known solvents. The solvents are thereafter removed to form the coating layer.

In some aspects, the containments of the present disclosure includes a material layer which may include one or more composites, auxiliary materials, materials, nanomaterials and/or nanoparticles (NPs). In some aspects, the nanomaterial is provided as a nanoparticle. It will be appreciated that a nanoparticle can be of about 1 to about 100 nm in diameter or cross-sectional width, including about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 nm. With regard to the nanomaterials, it will be appreciated that the dimensions of such may vary depending on the material at issue, taking into account the shape and composition, as well as a discernable size. It will also be appreciated that a nanomaterial may present a material with a size on a nanoscale.

PVA is a water-soluble polymer, but its solubility can vary depending on several factors such as degree of hydrolysis, molecular weight, and temperature. PVA is an excellent oxygen barrier when dry, but its effectiveness decreases when exposed to moisture. PVA is offers good adhesive properties on various surfaces. PVA is biodegradable. PVA coatings can be used for food packaging or other sensitive products where oxygen exposure is detrimental. PVA also provides a good oil and grease barrier, especially useful in packaging applications. PVA can be used as a base coating for other materials due to its adhesive properties.

Gelatin is derived from collagen (animal origin), and is biodegradable. Gelatin has moderate water vapor barrier properties, but it swells and dissolves in water. Gelatin's physical properties are influenced by temperature. Due to its natural origins, gelatin is biodegradable, breaking down into harmless products in the environment, which is a significant advantage over synthetic polymers. Gelatin can be used in food packaging where an edible or dissolvable coating is desired. Gelatin is suitable for sustainable packaging solutions. Gelatin offers good oxygen barrier properties in dry conditions. Gelatin adds flexibility to the coating layer, allowing it to adjust to substrate properties.

Starch is a renewable, biodegradable material obtained from plants like corn, potatoes, and wheat. Soluble starch dissolves in water but can be modified to improve water resistance. Starch forms films that are flexible and adhesive. Starch offers moderate oxygen and grease barrier properties, but poor water resistance unless modified. Starch is completely biodegradable and environmentally friendly and it helps to degrade other materials faster. Starch-based coatings are biodegradable and can reduce reliance on synthetic polymers. Starch provides a good oil and grease barrier, making it useful for food packaging. Starch can be used as an adhesive or binding layer. Starch is relatively inexpensive compared to synthetic polymers.

Tannic acid is a polyphenol found in plant materials like oak bark and tea leaves. Tannic acid has natural antioxidant properties. It can interact with proteins and polysaccharides to form crosslinked networks and enhances its mechanical strength and barrier efficiency. In typical home composting, tannic acid is a crosslinking agent and it can help overall material will degrade as long as there is sufficient microbial activity and proper aeration. Tannic acid can improve the water-resistance of other materials when used as a crosslinker. Tannic acid is useful in food packaging to enhance shelf life by preventing microbial growth. Tannic acid can enhance oxygen and gas barrier properties when used in combination with other materials.

Glycerol is a hygroscopic compound that attracts moisture. It is commonly used as a plasticizer to increase the flexibility of other polymers like PVA, starch, and gelatin. Glycerol is soluble in water, which makes it prone to leaching when exposed to high humidity. Glycerol enhances the flexibility and workability of films, making them less brittle. It helps coatings to maintain flexibility, preventing cracks and improving durability. Suitable for coatings used in food or pharmaceutical applications, where safety is a concern.

Carnauba wax is derived from the leaves of the Brazilian palm tree and is biodegradable. It provides excellent water resistance due to its hydrophobic nature. Carnauba wax has a high melting point, which enhances the thermal stability of coatings. It is known for providing a glossy finish and increased hardness to coatings. Carnauba wax emulsions provide an excellent moisture barrier, making it ideal for waterproof coatings. It is suitable for eco-friendly packaging. It provides a smooth, glossy surface, enhancing the appearance of the coated substrate. It works well as an oil and grease barrier, making it ideal for food packaging.

Beeswax is a natural, nutrient-rich wax produced by young honey worker bees (genus Apis) from glands on their abdomens. Chemically, beeswax is composed of over 280 different compounds, primarily monoesters (45-55%), hydrocarbons (15-18%), free fatty acids (10-15%), diesters & complex esters (8-12%), hydroxy monoesters (4-6%), and free fatty alcohols (1-2%). Exact composition can vary by bee type, location and conditions. Beeswax enhances coatings by increasing water vapor resistance, adding antimicrobial properties, and boosting hydrophobic performance. Beeswax reduces moisture permeability, making biopolymers suitable for high-moisture contents and improving packaging structural integrity.

AKD Wax Emulsion (Alkyl Ketene Dimer) AKD wax emulsion is used in the paper industry to provide water repellency. AKD is highly hydrophobic, which makes it a good choice for creating water-resistant coatings. AKD forms a long-lasting and durable barrier after curing. AKD provides excellent protection against water and moisture penetration. AKD wax emulsions are particularly effective in creating water-resistant barriers on paper and cardboard. AKD provides long-lasting protection against water exposure. The cured AKD coating is resistant to a range of chemicals, making it suitable for packaging that may come into contact with various substances. AKD coatings exhibit good heat resistance, which enhances the stability of the barrier layer.

Polycaprolactone (PCL) is a biocompatible, biodegradable, and flexible semicrystalline polyester which enhances the coating layer properties. PCL's low melting point (60° C.), high adhesion, and slow degradation rate make it excellent for hydrophobic, protective coatings, particularly when blended with PLA, PEG, or natural polymers to enhance properties like wettability or biodegradation speed.

Montmorillonite (MMT) nanoclay may be included in the coating layer. MTT significantly enhance barrier properties (water vapor, oil, oxygen), mechanical strength, and thermal stability. For example, MMT fills the space between polymers, acting as a tortuous path for gases and moisture, decreasing moisture sensitivity and improving water vapor transmission rates (WVTR).

In some aspects, the coating layer may be provided as a pre-cursor liquid or gel form that allows for application as a spray, via dipping, or brushing for example, wherein it becomes a solid layer through the removal of one or more solvents therein. It will be understood that the final material of the coating layer is a solid material, yet to become the coating layer of the containment, the coating layer can be provided as a pre-cursor liquid or gel as previously noted. Accordingly, in some aspects, the material or composites may include a sprayable coating material, dippable coating material, brushable coating material, or be formulated therein, such as in combination with a dispersant or solvent. In some aspects, the pre-cursor liquid or gel can be sprayed onto the biopolymer layer of the containment and dried thereon to provide the coating layer. For example, the coating layer may be prepared in an aqueous solution or an organic solvent for the purposes of application to the biopolymer layer of the containment.

In some aspects, the coating layer may be formulated in a solvent or through multiple solvents in order to address solubility and even distribution within the final coating layer. Example solvents include: water, chloroform, ethanol, acetone, isopropyl alcohol, toluene, hexane, and other known organic solvents. For example, the solvent may be a 50:50 weight ratio of isopropyl alcohol and acetone. In some aspects, the solvent may include water. Such will be understood to include distilled, R.O. (reverse osmosis), or other purified waters.

It will be appreciated that formation of the coating layer is achieved with evaporation of solvents within the applied formulation. Such evaporation may be accelerated through adjusting the conditions such as heat and pressure to allow for the organic solvent to be completely removed from a final coating layer of the containment. Similarly, water or aqueous solutions may be evaporated from the applied formulation in order to provide a final solid coating layer.

In some aspects, the coating layer may be provided as a powder for application using heat and/or UV curable powder coating methods. For example, the coating layer may be generated by spraying charged powder electrostatically onto the biopolymer layer of the containment followed by heat and or ultraviolet (UV) light to melt and/or cure the charged powder into the coating layer.

In some aspects, the coating layer is a composite of two or more of the materials as set forth herein. In some aspects, the coating layer is formed by homogenizing the various components of the coating layer in a single solution and using the resulting solution to apply the coating layer to the biopolymer layer of the containment. In some aspects, the coating layer may include both suspended and dissolved materials in a single solution that is formed into the coating layer. For example, as set forth herein, the coating layer in some aspects includes one or more nanoparticles. In some aspects, the nanoparticles remain a solid during the formulation of the composite, resulting in even distribution throughout the final material. In some aspects, the coating layer may be formulated through a single homogenization or mixing process, or may be formulated in two or more steps, such as with adding a third material once a first and a second thereof are already mixed or homogenized. It will be apparent that formation of the coating layer may be the result of combining the various materials forming the coating layer all at once, individually, or in combinations to achieve the final coating layer.

In various aspects, the coating layer comprises at least one of polycaprolactone (PCL), alkyl ketene dimer (AKD), AKD nanoparticles, AKD wax, poly(vinyl) alcohol (PVA), polydimethylsiloxane (PDMS), beeswax, carnauba wax, citric acid, and montmorillonite (MMT) nanoclay.

In some aspects, the coating layer may be a combination of polyvinyl alcohol (PVA), montmorillonite (MMT) nanoclay, and wax emulsions. In particular embodiments, the coating layer may comprise a water-based coating made of PVA, MMT, and a blend of alkyl ketene dimer (AKD) and/or carnauba wax emulsions. The various components may be added to the water with heating to dissolve the various components. The PVA may be of high hydrolysis degree and molecular weight. For example, the PVA may have a hydrolysis degree greater than 98% and molecular wright between 85,000 and 124,000 Da. Further, the MMT nanoclay may be exfoliated with high-spear or ultrasonic mixing. Such coating comprises a polyvinyl alcohol (PVA) matrix integrated with montmorillonite (MMT) nanoclay for mechanical reinforcement and impermeability enhancement, combined with hydrophobic AKD wax and/or carnauba wax emulsions to increase water resistance and oxygen barrier properties. This coating layer is believed to significantly improve water vapor and oxygen barrier properties while maintaining biodegradability.

In some aspects, the coating layer may be a combination of PVA, MMT, wax emulsions, and PDMS. In particular embodiments, the coating layer may comprise a two-layer barrier coating system applied externally on PLA/PHA-based containments. The first layer may include a water-based composite made of PVA, MMT, and a blend of AKD and carnauba wax emulsions. The various components may be added to the water with heating to dissolve the various components. After drying the first layer, a second layer of PDMS may be applied via spray coating or other application means. This multilayer system is believed to significantly improve water vapor and oxygen barrier properties while maintaining biodegradability. Additionally, each of the components are food-contact safe.

In some aspects, the coating layer may be about 15 to 25% by weight PVA, about 5-15% by weight MMT, about 25-45% by weight AKD wax emulsion, about 25-45% by weight carnauba wax emulsion, and about 2-10% by weight PDMS. In some aspects, the coating layer may be about 14-24% by weight PVA, about 3-11% by weight MMT, about 29-39% by weight AKD wax emulsion, about 29-39% by weight carnauba wax emulsion, and about 2-8% by weight PDMS. In some aspects, the coating layer may be about 17-20% by weight PVA, about 6-8% by weight MMT, about 33-36% by weight AKD wax emulsion, about 33-36% by weight carnauba wax emulsion, and about 3-6% by weight PDMS. In one or more specific aspects, the coating layer may be about 18.6% by weight PVA, about 7% by weight MMT, about 34.4% by weight AKD wax emulsion, about 34.4% by weight carnauba wax emulsion, and about 4.7% by weight PDMS. This coating layer is believed to significantly improve water vapor and oxygen barrier properties while maintaining biodegradability. Additionally, each of the components are food-contact safe.

In some aspects, the coating layer may be about 15 to 25% by weight PVA, about 5-15% by weight MMT, about 25-45% by weight AKD wax emulsion, and about 25-45% by weight carnauba wax emulsion. In some aspects, the coating layer may be about 15-25% by weight PVA, about 3-11% by weight MMT, about 31-41% by weight AKD wax emulsion, and about 31-41% by weight carnauba wax emulsion. In some aspects, the coating layer may be about 18-21% by weight PVA, about 6-8% by weight MMT, about 35-38% by weight AKD wax emulsion, and about 35-38% by weight carnauba wax emulsion. In one or more specific aspects, the coating layer may be about 19.5% by weight PVA, about 7.3% by weight MMT, about 36.6% by weight AKD wax emulsion, and about 36.6% by weight carnauba wax emulsion. This coating layer is believed to significantly improve water vapor and oxygen barrier properties while maintaining biodegradability. Additionally, each of the components are food-contact safe.

In some aspects, the coating layer may be a combination of beeswax and PCL. In particular embodiments, the coating may comprise beeswax and polycaprolactone (PCL), solvated in a binary solvent system of isopropyl alcohol and acetone for application to the exterior surface of polylactic acid (PLA) and polyhydroxyalkanoate (PHA) containment. The various components may be added to the solvent system with heating to dissolve the PCL and beeswax. In some aspects, the coating may be about 25-75% by weight beeswax and about 25-75% by weight PCL. In some aspects, the coating layer may be of about 33% by weight beeswax and about 67% by weight PCL. In some aspects, the coating layer may additionally include citric acid with about 25-75% by weight beeswax, about 25-75% by weight PCL, and about 5-15% by weight citric acid. This coating layer is believed to significantly improve water vapor and oxygen barrier properties while maintaining biodegradability. Additionally, each of the components are food-contact safe.

In some aspects, the coating layer may be a combination of beeswax, carnauba wax, and PCL. In particular embodiments, the coating layer may comprise beeswax, carnauba wax, and polycaprolactone (PCL), solvated in a binary solvent system of isopropyl alcohol and acetone for application to the exterior surface of polylactic acid (PLA) and polyhydroxyalkanoate (PHA) containment. The various components may be added to the solvent system with heating to dissolve the PCL, carnauba wax, and beeswax. In some aspects, the coating may be about 10-25% by weight beeswax, about 15-40% by weight carnauba wax, and about 25-75% by weight PCL. In some aspects, the coating layer may be of about 18% by weight beeswax, about 32% by weight carnauba wax, and about 50% by weight PCL. In some aspects, the coating layer may additional include citric acid with about 10-22% by weight beeswax, about 20-40% by weight carnauba wax, about 30-60% by weight PCL, and about 5-15% by weight citric acid. In some aspects, the coating layer may be of about 11-21% by weight beeswax, about 24-34% by weight carnauba wax, about 40-50% by weight PCL, and about 6-16% by weight citric acid. In some aspects, the coating layer may be of about 14-18% by weight beeswax, about 26-32% by weight carnauba wax, about 42-48% by weight PCL, and about 8-14% by weight citric acid. In one or more specific aspects, the coating layer may additional may be of about 15.9% by weight beeswax, about 28.7% by weight carnauba wax, about 44.6% by weight PCL, and about 10.8% by weight citric acid. This coating layer is believed to significantly improve water vapor and oxygen barrier properties while maintaining biodegradability. Additionally, each of the components are food-contact safe.

In some aspects, the coating layer may be a combination of beeswax, carnauba wax, citric acid, and PCL. In particular embodiments, the coating layer may comprise a two-layer barrier coating system applied externally on PLA/PHA-based containments. The first layer may include beeswax, carnauba wax, citric acid, and polycaprolactone (PCL), solvated in a binary solvent system of isopropyl alcohol and acetone for application to the exterior surface of polylactic acid (PLA) and polyhydroxyalkanoate (PHA) containment. The various components may be added to the solvent system with heating to dissolve the PCL, carnauba wax, and beeswax. In some aspects, the first coating layer may be about 10-25% by weight beeswax, about 25-40% by weight carnauba wax, about 30-50% by weight PCL, and about 5-15% by weight citric acid. In some aspects, the first coating layer may be of about 13-24% by weight beeswax, about 28-38% by weight carnauba wax, about 32-42% by weight PCL, and about 6-16% by weight citric acid. In some aspects, the first coating layer may be of about 15-22% by weight beeswax, about 28-38% by weight carnauba wax, about 32-42% by weight PCL, and about 8-14% by weight citric acid. In one or more specific aspects, the first coating layer may be of about 18.5% by weight beeswax, about 33.3% by weight carnauba wax, about 37% by weight PCL, and about 11.1% by weight citric acid. After drying the first layer, a second layer of PCL and citric acid may be applied via spray coating or other application means. The second coating layer may include PCL and citric acid, solvated in a binary solvent system of isopropyl alcohol and acetone for application to the first coating layer. The various components may be added to the solvent system with heating. In some aspects, the second coating layer may be about 85-95% by weight PCL and about 5-15% by weight citric acid. In one or more specific aspects, the second coating layer may be of about 91% by weight PCL and about 9% by weight citric acid. This multilayer system is believed to significantly improve water vapor and oxygen barrier properties while maintaining biodegradability. Additionally, each of the components are food-contact safe.

In some aspects, the coating layer may be a combination of alkyl ketene dimer (AKD) wax and polycaprolactone (PCL). In particular embodiments, the coating may comprise AKD wax and PCL dissolved in an organic solvent system. The various components may be added to the solvent system with heating to dissolve the PCL and AKD wax. In some aspects, the coating layer may be about 25-75% by weight AKD wax and about 25-75% by weight PCL. In some aspects, the coating layer may additionally include citric acid with about 40-60% by weight PCL, about 30-50% by weight AKD wax, and about 5-15% by weight citric acid. In some aspects, the coating layer may be of about 45-55% by weight PCL, about 35-45% by weight AKD, and about 5-15% by weight citric acid. In some aspects, the coating layer may be of about 46-56% by weight PCL, about 35-45% by weight AKD, and about 4-14% by weight citric acid. In some aspects, the coating layer may be of about 48-54% by weight PCL, about 38-44% by weight AKD, and about 6-12% by weight citric acid. In some aspects, the coating layer may be of about 49-51% by weight PCL, about 39-41% by weight AKD wax, and about 9-11% by weight citric acid. In one or more specific aspects, the coating layer may be of about 50.8% by weight PCL, about 40.1% by weight AKD, and about 9.1% by weight citric acid. In one or more specific aspects, the coating layer may be of about 50% by weight PCL, about 40% by weight AKD, and about 10% by weight citric acid. This coating layer is believed to significantly improve water vapor and oxygen barrier properties while maintaining biodegradability. Additionally, each of the components are food-contact safe.

In some aspects, the coating layer may be a combination of PCL, AKD, and citric acid. In particular embodiments, the coating layer may comprise a two-layer barrier coating system applied externally on PLA/PHA-based containments. The first layer may include PCL, AKD, and citric acid, solvated in a binary solvent system of isopropyl alcohol and acetone for application to the exterior surface of a polylactic acid (PLA) and polyhydroxyalkanoate (PHA) containment. The various components may be added to the solvent system with heating to dissolve the PCL and AKD. In some aspects, the first coating layer may be about 30-60% by weight PCL, about 30-60% by weight AKD, and about 5-15% by weight citric acid. In some aspects, the first coating layer may be of about 40-50% by weight PCL, about 40-50% by weight AKD, about 5-15% by weight citric acid. In one or more specific aspects, the first coating layer may be of about 45.5% by weight PCL, about 45.5% by weight AKD, and about 9% by weight citric acid. After drying the first layer, a second layer of PCL and citric acid may be applied via spray coating or other application means. The second coating layer may include PCL and citric acid, solvated in a binary solvent system of isopropyl alcohol and acetone for application to the first coating layer. The various components may be added to the solvent system with heating. In some aspects, the second coating layer may be about 85-95% by weight PCL and about 5-15% by weight citric acid. In one or more specific aspects, the second coating layer may be of about 91% by weight PCL and about 9% by weight citric acid. This multilayer system is believed to significantly improve water vapor and oxygen barrier properties while maintaining biodegradability. Additionally, each of the components are food-contact safe.

In some embodiments, the first coating layer and the second costing layer of the various disclosed multilayer systems may be duplicated. Specifically, the first coating layer (“A”) and the second coating layer (“B”) may be repeated in accordance with various patterns. For example, the first coating layer and the second coating layer may be repeated in accordance with ABAB, AAAA, AABB, AABAAB, or ABBABB. While the provided examples include 4 to 6 layers, it will be appreciated that embodiments with 2 layers, 3 layers, and greater than 6 layers are equally envisioned.

As previously noted, in some aspects the coating layer is applied to the cap and in further aspects, the cap does not include a coating layer.

In some aspects, the coating layer includes PVA and/or PHA and one or more additional components, either alone or in combination with one or more components as set forth herein. In some aspects, PVA/PHA is from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include a further biopolymer such as PPC from about 5 to about 80 percent by weight of the final composite or material of the containment, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer includes PCL. In some aspects, PCL is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include a polysaccharide or a polymer of saccharides or a carbohydrate, such as cellulose, cellulose acetate, glycerol, gelatin, starch, corn starch, or a lignin. In some aspects, the polysaccharide/carbohydrate is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include EVOH. In some aspects, EVOH is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer includes a wax, such as beeswax, carnauba wax, carnauba wax emulsion, AKD, AKD wax, AKD wax emulsion and/or AKD nanoparticles. In some aspects, the wax is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer includes PDMS. In some aspects, PDMS is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer includes citric acid. In some aspects, citric acid is from about 1 to about 70 percent by weight of the final coating layer, including about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, and 69 percent by weight of the final coating layer.

In some aspects, the coating layer may include a starch-based polysaccharide, including starches obtained from plants and vegetables, such as tree, tubers, corn, barley, wheat, cereal grains, and root vegetables. In some aspects, the starch is derived from yams, maize, cassava, corn, palm trees (such as Palm Sago), or a combination thereof. In some aspects, starch is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include TEOS. In some aspects, TEOS is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include bTPU. In some aspects, bTPU is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In some aspects, the coating layer may include MMT. In some aspects, MMT is from about 5 to about 80 percent by weight of the final coating layer, including about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 percent by weight of the final coating layer.

In one or more embodiments, an additional coating layer or waterproof film may be provided. Specifically, in aspects which utilize water as the solvent, the coating layer may be subject to melting or becoming tacky when exposed to moisture or wet hands. Accordingly, a top coat may be applied to protect the coating layer from moisture.

### EXAMPLES

### Bottles

To demonstrate the feasibility and utility of containments produced in accordance with various aspects of the present disclosure, test bottles were generated and tested for various performance properties.

### PLA/PHA/Erucamide/Silica Bottle

A 23 g biodegradable bottle composed of 50% Polylactic Acid (PLA), 45% Polyhydroxyalkanoates (PHA), and 5% Biodegradable Auxiliary Agents (50:45:5 weight ratio) was assessed. The auxiliary agents included 2% erucamide and 3% nano silica additive. PLA and PHA are dried at 60-80° C. to remove moisture. The two polymers are mixed in a twin-screw extruder at a temperature range of 180-210° C. The biodegradable auxiliary agent is introduced to enhance compatibility and processability. The blended material is pelletized and fed into an injection molding machine. Preforms are created and conditioned for blow molding. Using a stretch blow molding process, the preforms are expanded into 23 g biodegradable bottles. The resulting bottle had comparable strength and flexibility to PET bottles, with a degradation time of 6-12 months.

### PLA/PPC-P/Compactive Additive

A biopolymer bottle of PLA, PPC-P, and Compactable Additive for Enhanced Strength, Flexibility, and Degradability at a 70:30:3 weight ratio was assessed. This bottle is intended for packaging applications, offering enhanced environmental sustainability due to its biodegradable and compostable nature, while maintaining mechanical strength, flexibility, and functional properties suitable for commercial use. The components (PLA, PPC-P, and compactable additive) are mixed in the required ratios (70:30:3) using an extruder. The mixture undergoes melt blending at a controlled temperature between 150° C. to 180° C. The extruder ensures homogeneous distribution of the additive in the PLA-PPC-P matrix, ensuring the desired mechanical and physical properties. The melted blend is then cooled and granulated to form polymer pellets suitable for injection molding or blow molding. The polymer pellets are heated to form a molten polymer. This molten polymer is then used in either injection molding or blow molding processes to create the final bottle design. Parameters such as temperature, pressure, and cooling time are adjusted to optimize the final product's performance (e.g., strength, flexibility, and finish). After molding, the bottle is rapidly cooled, and post-processing steps such as trimming and surface finishing are applied. The final product was subjected to mechanical testing (tensile strength, elongation at break, impact resistance), barrier property testing (gas permeability), and biodegradability testing. Laboratory testing of the biopolymer blend (70% PLA, 30% PPC-P, and 3% compactable additive) shows significant improvement in mechanical properties when compared to pure PLA. Tensile Strength: Improved by 25% compared to pure PLA. Elongation at Break: Enhanced by 40%, making the material more flexible and less prone to cracking. Impact Resistance: Increased by 30%, allowing the bottle to withstand external shocks without deformation.

The inclusion of PPC-P significantly improves gas and moisture barrier properties, reducing oxygen and carbon dioxide permeation by 50% compared to a 100% PLA bottle.

### PLA/PHBV/Antioxidant

A 38 mm neck finish 15.5 g and 120 cc volume bottle made from a composition of Polylactic Acid (PLA), Poly(3-hydroxybutyrate-co-3-hydroxyvalerate) (PHBV), and antioxidant additive at a 80:20:0.2 weight ratio was assessed. The manufacturing process for producing the 120 cc biopolymer bottles involves extrusion compounding, injection molding, and stretch blow molding. Pre-dried raw materials are mixed and fed into an extruder, where they are melted and compounded at a temperature range of 170° C. to 190° C. This process ensures the uniform dispersion of the PHBV and antioxidant additive within the PLA matrix, resulting in a homogenous polymer blend. The compounded material is cooled and pelletized into small granules. These granules are the feedstock for the injection molding process used to create the bottle preforms. The biopolymer granules are fed into an injection molding machine and melted at a temperature of 160° C. to 180° C. The molten polymer is injected into molds to create preforms for the 38 mm neck finish 120 cc bottle. The preforms are then cooled and ejected from the molds. The preforms are reheated to the optimal temperature for blow molding and then placed in a blow mold and blown into the final bottle shape using compressed air. The 120 cc volume bottle is formed with precision, ensuring consistency in wall thickness and shape.

The tensile strength of the biopolymer blend was measured at 45-50 MPa, indicating sufficient strength to withstand typical stresses encountered during packaging, transportation, and handling. The elongation at break was measured at 20-25%, demonstrating the blend's improved flexibility compared to pure PLA, reducing the likelihood of cracking or breaking. The melting point of the biopolymer blend was recorded at 160-170° C., confirming the suitability of the material for typical processing conditions. The oxygen barrier properties of the bottle were significantly improved by the presence of PHBV.

### PLA/PBS/Antioxidant

A bottle with a 38 mm neck finish, weighing 15.5 g, and with a volume of 120 cc was assessed. The bottle is produced using a blend of Polylactic Acid (PLA), Polybutylene Succinate (PBS), and antioxidant additive at a 70:30:0.2 weight ratio. The PLA, PBS, and antioxidant additive are dried thoroughly to eliminate moisture, which can cause degradation during melt processing. The dried components are fed into an extruder, where they are melted and blended at temperatures ranging from 160° C. to 180° C. The compounding process ensures a homogenous mixture of PLA, PBS, and the antioxidant additive, resulting in a uniform biopolymer blend. After compounding, the blend is cooled and pelletized into small granules for ease of further processing. The biopolymer granules are then melted and injected into molds to form preforms with the 38 mm neck finish. These preforms are shaped to meet the dimensional requirements of the final bottle. The preforms are heated to a specific stretching temperature and blown into the final bottle shape using a stretch blow molding machine. This step ensures the proper wall thickness, bottle dimensions, and total weight of 15.5 g.

The bottle exhibited a tensile strength of approximately 38 MPa. The addition of PBS resulted in a 25-30% elongation at break, which significantly improved the flexibility of the bottle compared to pure PLA. The melting temperature of the blend was found to be in the range of 160-170° C., which allows for efficient processing through injection molding and blow molding techniques.

### PLA/PBS/Compatibilizer

A biopolymer blend comprising polylactic acid (PLA), polybutylene succinate (PBS), and compatibilizing additives at a 80:20:3 weight ratio was assessed. The compatibilizer functions as a molecular bridge, improving the interfacial adhesion between PLA and PBS, thereby enhancing the mechanical and thermal properties of the blend. PLA and PBS are blended in a twin-screw extruder at temperatures between 170° C. and 200° C. The compatibilizer is added during extrusion to ensure uniform dispersion and maximum interaction between the PLA and PBS phases. The polymer blend is then processed using injection molding or blow molding techniques to form bottles. The temperature for injection molding is maintained between 180° C. and 210° C., while blow molding for bottle formation is performed at temperatures between 200° C. and 220° C. Bottles are annealed to improve crystallinity and thermal stability.

Through the incorporation of 20% PBS and the compatibilizer, the blend demonstrates superior mechanical properties compared to pure PLA. Key improvements include: Tensile Strength: Increased by 10-20% compared to neat PLA. Impact Resistance: PBS enhances toughness, reducing the brittleness commonly associated with PLA. Elongation at Break: The blend exhibits elongation levels of 10-15%. Thermal Resistance: Heat distortion temperature improves by 5-10° C. due to the enhanced crystallinity of the PBS component. Water Vapor Permeability: Slightly reduced compared to neat PLA, making the material suitable for packaging products sensitive to moisture.

| | | PLA + PBS + Compatibilizer |
|---|---|---|
| Property | Pure PLA | (80:20:3 weight ratio) |
| Tensile Strength (MPa) | 50-60 | 55-70 |
| Elongation at Break (%) | 3-5 | 10-15 |
| Impact Strength (kJ/m²) | 12-4 | 5-8 |
| Heat Distortion Temp | 55-60 | 60-65 |
| (° C.) | | |

### PLA/BPAT/Antioxidant

A Polylactic Acid (PLA), Polybutylene Adipate Terephthalate (PBAT), and antioxidant additive composition at a 50:50:0.2 weight ratio for a bottle with a 38 mm neck finish, 15.5 g weight, and 120 cc volume was assessed. PLA, PBAT, and the antioxidant additive are first dried to eliminate moisture content, which could negatively affect the material properties during processing. The dried materials are fed into a twin-screw extruder operating at temperatures between 170° C. to 200° C. The extrusion process ensures thorough mixing of the PLA, PBAT, and antioxidant, resulting in a homogeneous biopolymer blend. The compounded material is cooled and pelletized into uniform granules, which are used for the next stage of production. The granulated biopolymer is melted and injected into a preform mold to produce the preforms. The preform includes the 38 mm neck finish and other key dimensional characteristics required for the final bottle shape. The preforms are reheated and placed in a stretch blow molding machine, where they are inflated into the final bottle shape. This process ensures proper wall thickness distribution and mechanical strength across the bottle.

The bottle was subjected to several mechanical tests, including tensile strength, elongation at break, impact resistance, and flexural properties. The tests were performed to evaluate the blend's performance in real-world packaging applications. Tensile Strength: The bottle exhibited a tensile strength of 30-35 MPa. Elongation at Break: The elongation at break was measured at approximately 60-70%, indicating good flexibility and the ability to deform without breaking. Impact Resistance: The impact resistance test demonstrated that the bottle could withstand drops from heights of up to 1.5 meters. Melting Temperature (Tm): The melting temperature of the blend was observed at 165° C. to 170° C., ensuring processability during injection molding and stretch blow molding. Thermal Degradation: The presence of the antioxidant prevented significant thermal degradation during processing, maintaining material stability.

### PLA/PHBV/Additive

A bottle of a blend of polylactic acid (PLA), poly(3-hydroxybutyrate-co-3-hydroxyvalerate) (PHBV), and Ecoflex F Blend C1200 (additive) at a 55:45:5 weight ratio was assessed. The PLA, PHBV, and Ecoflex are uniformly mixed in precise proportions of 55% PLA, 45% PHBV, and 5% Additive. The blend can be pelletized for further processing. The biopolymer blend was processed using injection molding. Injection Molding Parameters: Temperature: 180-200° C.; Mold Temperature: 20-30° C.; and Pressure: 10-15 MPa. The Ecoflex component is uniformly dispersed in the PLA/PHBV matrix to ensure homogeneity in the final material. Once molded, the bottles are cooled and can be trimmed or finished as needed.

The bottle exhibited the following properties: Tensile Strength: 40-60 MPa, combining the rigidity of PLA and the flexibility of PHBV. Elongation at Break: Improved to 5-10% due to the addition of Ecoflex, which reduces brittleness. Impact Resistance: Increased compared to pure PLA. Thermal Stability: The bottle can withstand temperatures up to 50-60° C. without deformation.

| | | | Ecoflex | |
|---|---|---|---|---|
| Property | PLA | PHBV | (Additive) | Final Blend |
| Tensile Strength | High | Moderate | Low | Optimized |
| Elongation at | Low | High | Very High | Improved |
| Break | | | | (Balanced) |
| Flexibility | Moderate | High | Very High | High |
| Impact | Low | Moderate | High | High |
| Resistance | | | | |

The combined formulation exhibits faster biodegradability compared to pure PLA. Under industrial composting conditions, the bottle will break down within 6 to 12 weeks.

### PLA/PHBV/Additive

A biopolymer blend of polylactic acid (PLA), poly(3-hydroxybutyrate-co-3-hydroxyvalerate) (PHBV), and Ecoflex F Blend C1200 as a compatibilizer/additive at a 65:35:5 weight ratio for manufacturing 28 mm neck finish bottles with a weight range of 21-27 grams (PCO 1810 standard) was assessed. The polymers (PLA and PHBV) and the additive (Ecoflex F Blend C1200) are compounded in a twin-screw extruder. The blending is done at a temperature range of 160° C. to 190° C. to ensure a homogeneous mixture. Ecoflex is added during the extrusion process to enhance the interaction between PLA and PHBV. The blend is processed into preforms using injection molding or blow molding. The melt temperature is maintained at approximately 180° C. to 210° C., depending on the specific processing equipment and requirements. The 28 mm neck finish, conforming to the PCO 1810 standard, is designed during the molding process, with the final bottle weight controlled to 21-27 grams. After molding, bottles are subjected to a controlled cooling process to improve their crystallinity and thermal stability.

The PLA-PHBV-Ecoflex blend exhibits significantly improved mechanical properties compared to either PLA or PHBV alone, particularly in terms of flexibility and impact resistance. The following key mechanical properties were measured. Tensile Strength: Increased by 10-15% compared to pure PLA, providing sufficient strength for bottle applications. Elongation at Break: Up to 25%, offering enhanced flexibility that reduces the risk of bottle cracking or deformation under pressure or during transport. Impact Resistance: Ecoflex F Blend C1200 significantly improves the toughness of the bottle, making it resistant to mechanical impact and deformation. Thermal Resistance: The blend has a heat distortion temperature between 55° C. and 65° C.

PHBV improves the water vapor barrier properties compared to neat PLA, making the bottle more suitable for liquid storage. The blend has moderate oxygen barrier properties, acceptable for the storage of non-carbonated beverages and other non-perishable liquids.

| | | PLA + PHBV + Ecoflex F Blend C1200 |
|---|---|---|
| Property | Pure PLA | (65:35:5 weight ratio) |
| Tensile Strength (MPa) | 50-60 | 55-65 |
| Elongation at Break (%) | 3-5 | 20-25 |
| Impact Strength (kJ/m²) | 2-4 | 6-9 |
| Heat Distortion Temperature | 50-55 | 55-65 |
| (° C.) | | |
| Estimated Biodegradation | 6-12 | 6-12 |
| Time (Months) | | |

### PLA/PBAT/Antioxidant

A blend of Polylactic Acid (PLA), Polybutylene Adipate Terephthalate (PBAT), and antioxidant additive at a 60:40:0.2 weight ratio was assessed for a 38 mm neck finish, 15.5 g weight, and 120 cc volume bottle. The PLA, PBAT, and antioxidant additive are first dried to remove any moisture, which could negatively affect the properties of the blend during processing. The dried materials are compounded in a twin-screw extruder at temperatures ranging from 170° C. to 200° C. This process ensures that the PLA, PBAT, and antioxidant are thoroughly mixed, resulting in a homogeneous blend. The compounded material is cooled and pelletized into small granules that are ready for further processing. The biopolymer granules are melted and injected into a preform mold to produce preforms with the desired 38 mm neck finish. The preforms are reheated and placed into a stretch blow molding machine, where they are blown into the final bottle shape. This process improves the mechanical strength and wall thickness distribution of the bottle.

The bottle was subjected to various mechanical tests, including tensile strength, elongation at break, impact resistance, and flexural properties. Tensile Strength: The tensile strength of the bottle was measured to be between 30-35 MPa, providing sufficient resistance to stretching and tearing. Elongation at Break: The elongation at break was measured at 50-60%, indicating good ductility and the ability to deform without breaking. Impact Resistance: Absorbed forces from drops of 1-1.5 meters without cracking, a significant improvement over PLA-only bottles. Flexural Strength: The bottle exhibited good resistance to bending forces, maintaining structural integrity during typical handling and shipping conditions.

The melting temperature of the material was observed at 165-170° C., ensuring processability during injection molding and blow molding operations. The presence of the antioxidant prevented significant degradation during thermal processing, ensuring material stability during manufacturing.

### PLA/PBS/Antioxidant

A biodegradable polymer bottle made using a blend of Polylactic Acid (PLA), Polybutylene Succinate (PBS), and antioxidant additive at a 60:40:0.2 weight ratio was assessed. The bottle comprised a 38 mm neck finish, 15.5 g weight, and 120 cc volume. The PLA, PBS, and antioxidant additive are dried to remove any moisture, which can affect the performance of the material during processing. Moisture removal is critical to avoid hydrolysis during melt processing. The dried components are compounded in a twin-screw extruder at temperatures ranging from 170° C. to 190° C. During this process, PLA, PBS, and the antioxidant are thoroughly mixed to form a homogeneous blend. The extrusion process is critical for ensuring even distribution of the antioxidant within the polymer matrix. After extrusion, the molten blend is cooled and pelletized to create small granules, which are easier to handle during the subsequent processing steps. The biopolymer pellets are melted and injected into molds to form preforms with the 38 mm neck finish. The preforms are reheated and blown into the final bottle shape using stretch blow molding. This process ensures proper wall thickness distribution and the desired weight of 15.5 g for the bottle.

The tensile strength of the bottle was measured at 35-40 MPa. The bottle exhibited an elongation at break of 20-30%. This elongation is significantly higher compared to pure PLA bottles. The bottle performed well in drop tests, withstanding impacts from a height of 1 meter without showing cracks or deformation. The bottle demonstrated good resistance to bending forces. The melting temperature was observed at 170-180° C., which allows for efficient processing of the material through standard molding techniques. The antioxidant additive helped improve the thermal stability of the material, preventing degradation during processing at elevated temperatures.

### PLA/PBAT/Antioxidant

A 38 mm 15.5 g bottle generated from a blend of Polylactic Acid (PLA), Polybutylene Adipate Terephthalate (PBAT), and antioxidant additive at a 70:30:0.2 weight ratio was assessed. The raw materials—PLA, PBAT, and the antioxidant additive—are pre-dried to remove any residual moisture, which could cause hydrolytic degradation during melt processing. The dried components are fed into an extruder, where they are heated and blended at temperatures ranging from 160° C. to 190° C. The extrusion process ensures uniform mixing of the PLA, PBAT, and antioxidant additive, resulting in a homogenous material blend. Once compounded, the blend is cooled and pelletized into small granules for further processing. The biopolymer granules are then fed into an injection molding machine, where they are melted and injected into preform molds. The preforms are shaped with a 38 mm neck finish, which will be blown into the final bottle shape. The preforms are heated and blown into the final bottle shape using a stretch blow molding machine.

The bottle demonstrated a tensile strength of 40 MPa, sufficient to maintain structural integrity under normal use. The bottle exhibited an elongation at break of 25-30%. The bottle showed significant improvements in impact resistance, withstanding drop tests without cracking. The melting temperature of the blend was around 165-170° C., allowing for high-temperature processing methods like injection and blow molding.

### PLA/PBAT/Antioxidant

A bottle of 38 mm neck finish, 120 cc volume 15.5 g weight of a composite of Polylactic Acid (PLA), Polybutylene Adipate Terephthalate (PBAT), and antioxidant additive at a 80:20:0.2 weight ratio was assessed. The PLA, PBAT, and antioxidant additive are pre-dried to remove any residual moisture that could cause hydrolytic degradation during processing. The dried materials are fed into an extruder, where they are heated and melted to a temperature range of 160° C. to 190° C. During this stage, the materials are uniformly blended, creating a homogeneous polymer composition. After compounding, the blend is cooled and pelletized into granules for further processing. The biopolymer granules are fed into an injection molding machine, where they are heated and injected into a mold to produce preforms with the required 38 mm neck finish. The preforms are heated and blown into the final bottle shape. This process ensures uniform wall thickness, proper bottle formation, and a 15.5 g weight with 120 cc capacity.

The biopolymer bottle exhibited a tensile strength of 45 MPa. With an elongation at break of 20-25%, the bottle demonstrated improved flexibility and resistance to cracking compared to PLA-only compositions. The biopolymer blend exhibited a melting temperature of 160-170° C., confirming its suitability for high-temperature processing.

### PLA/PBS/Antioxidant

A Polylactic Acid (PLA), Polybutylene Succinate (PBS), and antioxidant additive at a 80:20:0.2 weight ratio was assessed for a 38 mm 15.5 g 120 cc volume bottle. The raw materials (PLA, PBS, and antioxidant additive) are pre-dried to remove moisture. This prevents hydrolytic degradation during processing, which can weaken the final bottle structure. The pre-dried PLA, PBS, and antioxidant additive are fed into an extruder where they are melted and blended together at a temperature range of 160° C. to 190° C. This process ensures the homogeneous mixing of the materials, resulting in a uniform biopolymer blend. The compounded blend is cooled and pelletized into granules. These granules are later used as feedstock for injection molding. The biopolymer granules are melted and injected into molds to form preforms. The preforms are heated and blown into the final bottle shape using compressed air.

The tensile strength of the bottle was measured at 45-50 MPa. The elongation at break was measured at 15-20%, showing improved flexibility and resistance to cracking compared to pure PLA bottles. The biopolymer blend exhibited a melting point of 160-170° C., confirming that the material can be processed under conventional thermoplastic molding conditions.

### CAPS

### PLA/PHA/Erucamide/Nano Silica

Caps of a polymer blend of polylactic acid (PLA), polyhydroxyalkanoate (PHA), and biodegradable auxiliary agents at a weight ratio of 50:45:5 were assessed. PLA is a biodegradable thermoplastic derived from renewable resources such as corn starch and sugarcane. It provides structural rigidity, high tensile strength, and good processability in injection molding. PHA is a family of biodegradable polyesters produced by microbial fermentation. It enhances biodegradability and flexibility, compensating for PLA's brittleness. For the auxiliary agents, 2% was erucamide, a long-chain fatty acid amide that acts as a slip agent, reducing friction between surfaces and improving mold release properties during manufacturing, and 3% was a nano silica additive that provides enhanced surface smoothness, reduces friction, and improves barrier properties against moisture and gas permeability. Raw PLA and PHA pellets are dried to remove residual moisture. The biodegradable auxiliary agents are pre-mixed with the polymers to ensure uniform distribution. The mixture is processed using an extruder at optimized temperatures (160° C.-190° C.) to form a homogeneous blend. The molten polymer is cooled and pelletized for further processing. The compounded pellets are fed into an injection molding machine. The mold temperature is controlled at 50° C.-70° C. to prevent excessive crystallization. Molded caps are ejected and cooled under controlled conditions to maintain dimensional stability.

The tensile strength was comparable to PE caps, with improved flexibility attributed to the PHA incorporation.

### PLA/PHBV/Additive

A 28 mm PCO 1810 3.4 g beverage caps using a polymer blend of Polylactic Acid (PLA), poly(3-hydroxybutyrate-co-3-hydroxyvalerate) (PHBV), and DuPont Biomax Strong EP9000A at a weight ratio of 65:35:6.5 were assessed.

The biopolymer composition is processed using extrusion and injection molding techniques to produce the 28 mm PCO 1810 beverage caps. PLA, PHBV, and DuPont Biomax Strong EP9000A are pre-dried to remove moisture, which could affect the material properties during processing. The dried materials are mixed in the specified proportions: 65% PLA, 35% PHBV, and 6.5% DuPont Biomax. The mixed materials are fed into an extruder, where they are melted and compounded at a temperature range of 160° C. to 180° C. The extrusion process ensures thorough mixing of the components, promoting compatibility between PLA, PHBV, and the DuPont additive. The extruded material is cooled and pelletized. The pellets are fed into an injection molding machine where they are melted and injected into molds shaped for 28 mm PCO 1810 beverage caps. The molding parameters include: Injection temperature: 160° C. to 180° C.; Mold pressure: 50-100 MPa; and, Cooling time: 20-50 seconds.

The biopolymer blend was subjected to various mechanical, thermal, and biodegradability tests to evaluate its suitability for producing beverage caps. The 65% PLA, 35% PHBV, and 6.5% DuPont Biomax Strong EP9000A blend showed significant improvements in mechanical performance. Tensile Strength: Approximately 45-50 MPa. Elongation at Break: Increased to 25-30%, enhancing flexibility and reducing brittleness compared to pure PLA. Impact Resistance: Improved by 40-50%, making the caps more resilient to mechanical stresses during use and transport. Melting Temperature (Tₘ): about 170° C.

The barrier properties of the blend were evaluated to ensure that the caps provide adequate sealing for beverages: The blend exhibited sufficient barrier properties to minimize oxygen ingress, which is essential for maintaining beverage quality. The molded caps effectively prevented leakage under standard testing conditions.

### PLA/PBAT/Additive

A 30 mm 3.4 g caps for use in liquid packaging, made from a unique combination of Polylactic Acid (PLA), Polybutylene Adipate Terephthalate (PBAT), and DuPont Biomax Strong EP9000A at a weight ratio of 80:20:3 were assessed. The raw materials—PLA, PBAT, and DuPont Biomax Strong EP9000A—are pre-dried to remove any moisture content that could affect their mechanical and processing properties. The dried materials are then mixed in the specified proportions of 80% PLA, 20% PBAT, and 3% DuPont Biomax Strong EP9000A. The blend is fed into an extruder, where it is melted and mixed at a temperature range of 160° C. to 180° C. The extruder ensures the uniform distribution of the PBAT and Biomax additive within the PLA matrix, creating a homogeneous polymer blend. The compounded material is cooled and pelletized into small granules. The polymer granules are fed into an injection molding machine and melted at a temperature range of 160° C. to 180° C. The molten polymer is injected into molds shaped for 30 mm beverage caps. Molding parameters include: injection pressure 50-80 MPa, mold temp 30-50 C, cycle time 20-50 seconds.

The tensile strength of the blend was measured at approximately 40-45 MPa, sufficient to maintain the structural integrity of the beverage cap during use. The elongation at break increased to 30-35%, which is a significant improvement over pure PLA. This increased flexibility reduces the likelihood of cap cracking under stress. The impact strength was improved by 50-60%, providing the cap with the necessary toughness to resist damage during transportation and handling. The melting point of the composition was approximately 170-175° C., ensuring the material's suitability for thermoplastic processing methods. The beverage caps demonstrated adequate barrier properties to protect the contents of the bottles from oxygen ingress, which is crucial for maintaining the shelf life of beverages. The caps effectively prevented leakage under both static and dynamic testing conditions, proving their reliability in sealing carbonated and non-carbonated beverages.

### PLA/PHBV/Additive

A polylactic acid (PLA), poly(3-hydroxybutyrate-co-3-hydroxyvalerate) (PHBV), and Ecoflex F Blend C1200 at a weight ratio of 50:50:5 and designed for use in the manufacture of 2 g to 3.6 g closures for bottles was assessed. Ecoflex is flexible, and tough, and enhances the overall durability of the biopolymer blend. By adding 5% Ecoflex, the blend gains improved flexibility, impact resistance, and processability, making it suitable for bottle closures that require elasticity during usage. The biopolymer blend is achieved by melt-blending the three components—PLA, PHBV, and Ecoflex—in specific proportions (50%, 50%, and 5%, respectively). The blending process takes place at temperatures ranging from 160° C. to 180° C.

| Property | PLA | | PHBV | | Ecoflex | | Final Blend | |
|---|---|---|---|---|---|---|---|---|
| Tensile Strength | ~60 | MPa | ~39 | MPa | ~25-44 | MPa | ~45 | MPa |
| Elongation at | ~6% | | ~20% | | ~560% | | ~15% | |
| Break | | | | | | | | |
| Flexural | ~3.5 | GPa | ~1.5 | GPa | ~0.02 | GPa | ~2.8 | GPa |
| Modulus | | | | | | | | |
| Impact Strength | Low | | Medium | | High | | Medium | |
| Melting | 150-160° | C. | 175° | C. | 110-120° | C. | 160° | C. |
| Temperature | | | | | | | | |

| | | | | |
|---|---|---|---|---|
| Biodegradability | Yes | Yes | Yes | Yes |

The blend showed: Good mechanical strength suitable for bottle closures; Flexibility that prevents cracking during cap tightening and removal; Impact resistance for durability during transport and handling; and, Biodegradability, ensuring complete breakdown in composting facilities within a reasonable timeframe.

### PLA/PBAT/Antioxidant

A biodegradable bottle cap composed of a biopolymer blend made from Polylactic Acid (PLA), Polybutylene Adipate Terephthalate (PBAT), and antioxidant additive at a weight ratio of 60:40:0.2 was assessed. The dried PLA, PBAT, and antioxidant additive are fed into a twin-screw extruder, where they are heated to temperatures between 160° C. and 190° C. After extrusion, the molten polymer blend is cooled and pelletized. The compounded pellets are fed into an injection molding machine, where they are melted and injected into a mold designed to form the 38 mm neck, 4.5 g bottle cap. The mold is maintained at a controlled temperature to ensure proper flow and solidification of the polymer. Once molded, the cap is cooled to room temperature before being ejected from the mold.

The tensile strength of the PLA/PBAT blend was measured at 40-45 MPa. The elongation at break was significantly higher than pure PLA, measured at 30-40. Drop tests were conducted from heights of 1.5 meters, with the bottle caps exhibiting no signs of cracking or breaking, demonstrating excellent impact resistance. The melting temperature of the PLA/PBAT blend was observed to be between 120° C. and 160° C., making it suitable for typical injection molding processes. The glass transition temperature of the material was measured at 55° C., ensuring that the bottle cap remains stable under normal use conditions. The antioxidant additive effectively prevented degradation during high-temperature processing, with no discoloration or deterioration observed.

### PLA/PBS/Antioxidant

A biodegradable bottle cap made from a biopolymer blend comprising Polylactic Acid (PLA), Polybutylene Succinate (PBS), and antioxidant additive at a weight ratio of 60:40:0.2 was assessed for a the 38 mm neck finish, 4.5 g bottle cap. The PLA, PBS, and antioxidant additive are dried at 50° C. to 80° C. to remove any residual moisture that could cause defects during processing. The dried PLA and PBS pellets, along with the antioxidant additive, are compounded in a twin-screw extruder at temperatures ranging from 160° C. to 180° C. The compounded material is then cooled and cut into pellets. The PLA/PBS blend pellets are fed into an injection molding machine, where it is heated and injected into a custom mold designed for the 38 mm neck, 4.5 g bottle cap.

The tensile strength of the bottle cap was measured at 45 MPa. The elongation at break was observed at 50-60%. The bottle cap exhibited excellent impact resistance, withstanding drop tests from heights of 1.5 meters without cracking or deforming. The cap provided a leak-proof seal when fitted onto bottles, ensuring that it protected the contents from contamination and spillage. The melting temperature of the PLA/PBS blend was observed between 140° C. and 160° C., making it suitable for injection molding and other standard plastic processing techniques. The glass transition temperature of the blend was measured at 60° C., indicating that the material maintains stability under typical storage conditions. The antioxidant additive effectively prevented thermal degradation during molding, ensuring no discoloration or material breakdown.

### PLA/PHBV/Antioxidant

A blend of Polylactic Acid (PLA), Poly(3-hydroxybutyrate-co-3-hydroxyvalerate) (PHBV), and antioxidant additive at a weight ratio of 80:20:0.2 in a 38 mm neck, 4.5 g lightweight cap was assessed. The PLA, PHBV, and antioxidant additive are dried at appropriate temperatures (typically 60° C. to 80° C.) to remove moisture content, which can cause defects during processing. The dried PLA and PHBV granules, along with the antioxidant additive, are fed into a twin-screw extruder. The temperature inside the extruder is maintained between 160° C. to 190° C. to ensure a uniform melt and homogenous blending of the materials. The antioxidant additive is evenly dispersed throughout the polymer matrix during this process. Once the materials are compounded, the biopolymer blend is cooled and pelletized into small, uniform granules. The biopolymer pellets are fed into an injection molding machine where they are heated and injected into molds specifically designed for the 38 mm neck, bottle cap.

The tensile strength of the bottle cap was measured at 40-45 MPa. The cap exhibited an elongation at break of 50-55%. The bottle cap can withstand drop tests from heights of 1.5 meters without suffering cracks or fractures. The cap provided a secure seal when fitted onto bottles, ensuring leak-proof performance and protection of contents. The blend's melting temperature was observed at 160° C. to 175° C., ensuring good processability during injection molding without significant thermal degradation. The T_{g} of the blend was measured at 55° C., providing good thermal stability at normal ambient temperatures. The antioxidant additive effectively protected the polymers from thermal degradation during processing, with no significant discoloration or loss of mechanical properties observed.

### Coatings

Various coating formulations were assessed to demonstrate the utility of the present disclosure.

### PVA/MTT/AKD/Carnauba Wax

A single-layer coating with polyvinyl alcohol (PVA), montmorillonite (MMT) nanoclay, and wax emulsions was assessed. On a PLA/PHA-based substrate a coating layer of a water-based composite made of polyvinyl alcohol (PVA), montmorillonite (MMT) nanoclay, and a blend of AKD (alkyl ketene dimer) and carnauba wax emulsions was applied. Specifically, a PVA solution was prepared by dissolving 8 grams of PVA in 100 ml of distilled water at 90-95° C. with constant stirring until a clear homogeneous solution was obtained. A MMT Dispersion was also prepared by adding 3 grams of MMT nanoclay slowly into the hot PVA solution while stirring vigorously. Continuous stirring was maintained until the MMT was fully dispersed and exfoliated within the polymer matrix, ensuring no agglomerates remain. Such vigorous mixing was sustained for at least 30 minutes to ensure exfoliation and dispersion. Subsequently, 15 grams each of AKD and carnauba wax emulsions were added to the above mixture. Gentle stirring was maintained to avoid destabilizing the emulsions while ensuring uniform mixing. A uniform coating layer was applied on the external surface of a PLA/PHA biopolymer bottle using a spray method. The applied coating was dried at ambient conditions until the layer was fully set. Such applied one-layer coating adhered well to the biopolymer substrate. The coating also demonstrates biodegradability and environmental safety as a fully water-based formulation with no volatile organic compounds (VOCs).

### PVA/MMT/AKD Carnauba Wax PDMS

A Two-layer coating with polyvinyl alcohol (PVA), montmorillonite (MMT) nanoclay, wax emulsions, and polydimethylsiloxane (PDMS) was assessed. On a PLA/PHA-based substrate a first layer of a water-based composite made of polyvinyl alcohol (PVA), montmorillonite (MMT) nanoclay, and a blend of AKD (alkyl ketene dimer) and carnauba wax emulsions was applied. After drying the first layer, a second layer of polydimethylsiloxane (PDMS) was applied via spray coating. Specifically, a PVA solution was prepared by dissolving 8 grams of PVA in 100 ml of distilled water at 90-95° C. with constant stirring until a clear homogeneous solution was obtained. A MMT Dispersion was also prepared by adding 3 grams of MMT nanoclay slowly into the hot PVA solution while stirring vigorously. Continuous stirring was maintained until the MMT was fully dispersed and exfoliated within the polymer matrix, ensuring no agglomerates remain. The solution was cooled to 30° C. and then 15 grams each of AKD and carnauba wax emulsions were added to the above mixture. Gentle stirring was maintained to avoid destabilizing the emulsions while ensuring uniform mixing. The first coating layer was applied by coating the prepared solution uniformly on the external surface of a PLA/PHA biopolymer bottle using a spray method. The applied coating was dried at ambient conditions until the layer was fully set. After complete drying of the first layer, a thin layer of PDMS using a fine mist spray system was applied and allowed to cure and dry at room temperature to form a hydrophobic outer film. Such applied two-layer coating demonstrated strong adhesion to the PLA-PHA substrate and biodegradability.

### PCL/Beeswax

A single-layer coating with beeswax and polycaprolactone (PCL) was assessed. On a PLA/PHA-based substrate a coating of beeswax and polycaprolactone (PCL), solvated in a binary solvent system of isopropyl alcohol and acetone was applied. Specifically, the coating was prepared by simultaneously dissolving 5 grams of beeswax and 10 grams of PCL (Mn ~80,000) in 100 ml of a pre-mixed solvent system of isopropyl alcohol and acetone under constant stirring at ~50 to 60° C. until a uniform solution was obtained. The resultant solution was applied by coating the prepared solution uniformly on the external surface of a PLA/PHA biopolymer bottle using a spray method or dip-coating technique. The applied coating was dried at ambient conditions until solvent evaporation was completed and the coating layer was fully set.

### AKD/PCL

A single-layer coating with alkyl ketene dimer (AKD) wax and polycaprolactone (PCL) was assessed. On a PLA/PHA-based substrate a coating of alkyl ketene dimer (AKD) wax and polycaprolactone (PCL), solvated in a binary solvent system of isopropyl alcohol and acetone was applied. Specifically, the coating was prepared by simultaneously dissolving 5 grams of AKD wax and 10 grams of PCL in 100 ml of a pre-mixed solvent system of isopropyl alcohol and acetone under constant stirring until a uniform solution was obtained (~30 minutes). The resultant solution was applied by coating the prepared solution uniformly on the external surface of a PLA/PHA biopolymer bottle using a spray method, brush-coating, or dip-coating technique. The applied coating was dried at ambient conditions for 10-15 minutes until solvent evaporation was completed and the coating layer was fully set. A target dry film thickness of 5-10 microns was achieved for the coating.

### PVA/Gelatin/Starch/Tannic Acid/Citric Acid/Glycerol/Carnauba Wax/AKD Wax

A coating a PVA, gelatin, starch, tannic acid, citric acid, glycerol, carnauba wax (emulsion), AKD wax (emulsion), and water was assessed. An 8% to 10% PVA+5% Gelatin+3% Soluble Starch+3% Tannic acid+2% Citric acid+3% Glycerol solution in distilled water was prepared. These solutions were under constant stirring until a moderately thick solution formed. A 10% to 15% Carnauba wax emulsion+10% to 15% AKD wax emulsion was then added in the same ratio.

### PVA/Corn Starch

A corn starch bottle with polyvinyl alcohol (PVA) coating was prepared. Corn starch and polyvinyl alcohol (PVA) are biodegradable and water-soluble polymers. They are dissolved and formed to gel top coat on the sheet. The composition included: PLA sheet, 5% Corn starch, 5% PVA, and water. Briefly, 5% corn starch and 5% PVA solutions were prepared in distilled water. These solutions were kept under constant stirring until they formed gel. The gel was then coated on the sheet and kept for drying.

### Gelatin/PVA

A gelatin combination with polyvinyl alcohol (PVA) was next examined. Gelatin and polyvinyl alcohol (PVA) are biodegradable and water-soluble polymers. They are dissolved and formed to gel top coat on the PLA sheet. The composition included PLA sheet, 5% gelatin, 5% PVA, and water. Briefly, 5% gelatin and 5% PVA solutions were prepared in distilled water. These solutions were kept under constant stirring until they formed gel. The gel is coated on the sheet and kept for drying.

### Gelatin/Starch

Starch with a gelatin layer was also assessed. Gelatin and starch are biodegradable and water-soluble polymers. They are dissolved and formed to gel top coat the PLA sheet. The composition included PLA sheet, 5% gelatin, 5% starch, and water. Briefly, 5% gelatin and 5% starch solutions were prepared in distilled water. These solutions were kept under constant stirring until it formed a gel. The gel is coated on the sheet and kept for drying.

### PVA

A polyvinyl alcohol (PVA) as a barrier layer was assessed. Polyvinyl alcohol (PVA) is a biodegradable and water-soluble polymer. It is dissolved and formed into gel to coat the PLA sheet. The composition included PLA sheet, 10% PVA, and water. Briefly, 10% solution in distilled water was prepared. The solution is kept under constant stirring until it forms a gel. The gel is coated on the sheet and kept for drying.

### PVA/TEOS/Corn Starch

A corn starch layer in combination with PVA and TEOS was assessed. Corn starch and PVA are water-soluble polymers and biodegradable. TEOS is a cross-linker added to cross-link the corn starch and PVA in a gel state. The composition included PLA sheet, 5% corn starch, 5% PVA, 2 ml TEOS, and water. Briefly, 5% corn starch and 5% PVA solutions were prepared in distilled water. 5 ml of TEOS was added to cross-link the corn starch and PVA. These solutions were kept under constant stirring until they formed gel. The gel is coated on the sheet and kept for drying.

### PVA/TEOS/Gelatin

Gelatin in combination with polyvinyl alcohol (PVA) and TEOS was assessed. Gelatin and polyvinyl alcohol (PVA) are biodegradable and water-soluble polymers. They are dissolved and formed to gel top coat on the PLA sheet. The composition included PLA sheet, 5% gelatin, 10% PVA, 2 ml TEOS, and water. 5% gelatin and 5% PVA solutions were prepared in distilled water. These solutions were kept under constant stirring until it forms gel. The gel is coated on the sheet and kept for drying.

### PVA/Corn Starch/Gelatin

A corn starch layer in combination with polyvinyl alcohol (PVA) and gelatin was assessed. Corn starch, Gelatin and polyvinyl alcohol (PVA) are biodegradable and water-soluble polymers. They are dissolved and formed to gel top coat on the PLA sheet. The composition included PLA sheet, 5% gelatin, 5% PVA, 5% corn starch, and water. 5% corn starch, 5% gelatin, and 5% PVA solutions were prepared in distilled water. These solutions were kept under constant stirring until they formed gel. The gel is coated on the sheet and kept for drying.

### EVOH/AKD

An alternate coating with EVOH and AKD was assessed. The composition was a first layer: EVOH and a second layer: AKD. The materials included PLA sheet, 10% EVOH, 100% AKD, toluene, ethanol, and water. Briefly, 10% EVOH in was prepared in 1:4 ratio of ethanol and water and 100% AKD solution was prepared in toluene. These solutions were kept under constant stirring to dissolve completely. The EVOH solution and AKD wax solution are coated alternatively by dip coating and kept for drying.

### AKD/Wax/Corn Starch

Corn starch in combination with AKD wax was assessed. Corn starch is a biodegradable polymer. AKD wax prevents water penetration and enhances the hydrophobicity of the PLA sheet. The composition included PLA sheet, 10% corn starch, 10% AKD wax, and water. Briefly, 10% corn starch and 10% AKD were prepared in distilled water. These solutions were kept under constant stirring until it forms gel. The gel is coated on the sheet and kept for drying.

### PHA/AKD/CAB

A three-layer coating with PHA, AKD, and CAB was assessed. PHA and CAB are biodegradable polymers. PHA and CAB decrease the permeability. CAB is an excellent binder with other materials and is applied as an outermost coating. AKD wax prevents water penetration and enhances the hydrophobicity of the PLA sheet. The layers are as follow: First layer: PHA Second layer: AKD Third layer: CAB. The materials included PLA sheet, 10% PHA, 100% AKD, 5% CAB, toluene, DMSO, THF, and ethyl acetate. 10 g of PHA was added in 20 ml of DMSO. The solution is kept under constant stirring to dissolve completely. After completely solubalizing, make up the volume to 10% by adding 80 ml THF. 100% AKD solution was prepared in toluene. 5% CAB solution was prepared in ethyl acetate at constant stirring under temperature. Each solution was coated as separate layers.

### PHA/bTPU/PCL/CAB

A two-layer coating with PHA and bTPU, PCL, and CAB blends was assessed. PHA, bTPU, PCL, and CAB are biodegradable polymers. It acts as an excellent permeability barrier. CAB acts as an excellent binder with other materials and is applied as an outermost coating. The layers were as follow: First layer: PHA, Second layer: bTPU, PCL, and CAB blends. The composition included PLA sheet, 10% PHA, 10% bTPU, 10% CAB, 10% PCL, DMSO, and THF. A 10% PHA solution was prepared by initially adding 10 g of PHA in 20 ml of DMSO. The solution is kept under constant stirring to dissolve completely. After completely solubilizing, make up the volume to 10% by adding 80 ml THF. A 10% PCL, bTPU, and CAB solution was prepared in THF separately. The 10% PCL, bTPU, and CAB solution was then added together and mixed well. The PHA is coated as the first layer and PCL, bTPU, and CAB blends are coated as a second layer and kept by dip coating and for drying.

### Lignin/bTPU/PCL/CAB

A two-layer coating with kraft lignin and bTPU, PCL, and CAB blends was assessed. Kraft lignin, bTPU, PCL and CAB are biodegradable polymers. It acts as an excellent permeability barrier. CAB is an excellent binder with other materials and is applied as an outermost coating. The layers were as follow: First layer: Kraft lignin and Second layer: bTPU, PCL, and CAB blends. The composition included PLA sheet, 10% Kraft lignin, 10% bTPU, 10% CAB, 10% PCL, and THF. 10% kraft lignin solution was prepared in THF under constant stirring dissolve completely. The 10% PCL, bTPU, and CAB solution is added together and mixed well. The 10% PCL, bTPU, and CAB solution in THF was prepared separately. The 10% PCL, bTPU, and CAB solution is added together and mixed well. The kraft lignin is coated as a first layer and PCL, bTPU, and CAB blends are coated as a second layer and kept by dip coating and kept for drying.

### PHA/PPC/bTPU/PCL/CAB

A two-layer coating with PHA and PPC blends, and bTPU, PCL, and CAB blends was assessed. PHA, PPC, bTPU, PCL, and CAB are biodegradable polymers. It acts as an excellent permeability barrier. CAB is an excellent binder with other materials and is applied as an outermost coating. The layers were as follow: First layer: PHA and PPC blends and Second layer: bTPU, PCL, and CAB blends. The composition included PLA sheet, 10% PHA, 10% PPC, 10% bTPU, 10% CAB, 10% PCL, and THF. 10% PHA and 10% PPC solutions were prepared together in THF. A 10% PCL, bTPU, and CAB solution was prepared in THF separately. The 10% PCL, bTPU, and CAB solution is added together and mixed well. The PHA and PPC blended polymer solution is coated as the first layer onto the PLA sheet. After drying PCL, bTPU and CAB blended polymer solution is coated as a second layer and kept for drying.

bTPU/PCL/CAB

A single-layer coating with bTPU, PCL, and CAB. bTPU, PCL, and CAB are biodegradable polymers. It acts as an excellent permeability barrier. CAB is an excellent binder with other materials and is applied as an outermost coating. The composition included PLA sheet, 10% bTPU, 10% CAB, 10% PCL, and THF. A 10% PCL, bTPU, and CAB solution was prepared in THF separately. The 10% PCL, bTPU, and CAB solution is added together and mixed well. The blended polymer solution is applied as a single layer coating onto the PLA sheet and kept for drying.

### Kaolin Clay/Tannic Acid/AKD Wax/bTPU/PCL/CAB

A three-layer coating with Clay, tannic acid blends, AKD wax, and bTPU, PCL, and CAB blends was assessed. Kaolin Clay and tannic acid acts as a filler and increases the barrier properties. bTPU, PCL, and CAB are biodegradable polymers. It acts as an excellent permeability barrier. AKD and CAB act as an excellent binder with other materials and are applied as an outermost coating. The layers were as follows: First layer: Clay and tannic acid, Second layer: AKD wax, and Third layer: bTPU, CAB, and PCL. The composition included PLA sheet, 10% Kaolin clay, 10% Tannic acid, 100% AKD wax, 10% bTPU, 10% CAB, 10% PCL, THF, and toluene. Briefly, 10% clay and 10% tannic acid solutions were prepared in THF. 100% AKD solution was prepared in toluene. A 10% PCL, bTPU, and CAB solution was prepared in THF. Clay and tannic acid solution is coated as a first layer. After drying, AKD is coated second, followed by bTPU, PCL, and CAB and dried. The result was after 24 hr-208.19 g/m²/24 h.

### Kaolin Clay/Tannic Acid/bTPU/PCL/CAB

A two-layer coating with Clay, tannic acid blends, and bTPU, PCL, and CAB blends was assessed. Kaolin Clay and tannic acid acts as a filler and increases the barrier properties. bTPU, PCL, and CAB are biodegradable polymers. It acts as an excellent permeability barrier. CAB is an excellent binder with other materials and is applied as an outermost coating. The layers were as follow: First layer: Clay and tannic acid and Second layer: bTPU, CAB and PCL. The composition included PLA sheet, 10% Kaolin clay, 10% Tannic acid, 10% bTPU, 10% CAB, 10% PCL, and THF. 10% clay and 10% tannic acid solution was prepared in THF with constant stirring under low temperature. A 10% PCL, bTPU, and CAB solution was prepared in THF. Clay and tannic acid solution is coated as a first layer. After drying, AKD is coated followed by bTPU, PCL and CAB and dried.

### Kaolin Clay/bTPU/PCL/CAB

A single-layer coating with Clay, bTPU, PCL, and CAB blends was assessed. Kaolin Clay acts as a filler and increases the barrier properties. bTPU, PCL, and CAB are biodegradable polymers. It acts as an excellent permeability barrier. CAB is an excellent binder with other materials and is applied as an outermost coating. The composition included PLA sheet, 10% Kaolin clay, 10% bTPU, 10% CAB, 10% PCL, and THF. 10% clay in THF was prepared with constant stirring under low temperature. A 10% PCL, bTPU and CAB solution was prepared in THF. Everything was mixed and then coated as a single layer. A uniform coating of the blended solution was achieved.

### Tannic Acid/bTPU/PCL/CAB

A single-layer coating with tannic acid, bTPU, PCL, and CAB blends was assessed. Tannic acid acts as a filler and increases the barrier properties. bTPU, PCL, and CAB are biodegradable polymers. It acts as an excellent permeability barrier. CAB is an excellent binder with other materials and is applied as an outermost coating. The composition included PLA sheet, 10% tannic acid, 10% bTPU, 10% CAB, 10% PCL, and TIF. 10% Tannic acid, PCL, bTPU, and CAB solution was prepared in THF. Everything was then mixed and then coated as a single layer. A uniform coating of the blended solution was achieved.

### MMT/Tannic Acid/bTPU/PCL/CAB

A single-layer coating with MMT clay, tannic acid, bTPU, PCL, and CAB blends was assessed. Tannic acid acts as a filler and increases the barrier properties. bTPU, PCL, and CAB are biodegradable polymers. It acts as an excellent permeability barrier. CAB is an excellent binder with other materials and is applied as an outermost coating. The composition included PLA sheet, 30% MMT, 30% tannic acid, 10% bTPU, 10% CAB, 10% PCL, and THF. 30% MMT and 10% tannic acid, 10% PCL, 10% bTPU, and 10% CAB solution was prepared in THF with constant stirring under low temperature and then coated as a single layer. A uniform coating of the blended solution was achieved.

### EVOH/MMT/Tannic Acid/bTPU/PCL/CAB

A two-layer coating with EVOH, MMT clay, tannic acid, bTPU, PCL, and CAB blends was assessed. Tannic acid acts as a filler and increases the barrier properties. bTPU, PCL, and CAB are biodegradable polymers. It acts as an excellent permeability barrier. CAB is an excellent binder with other materials and is applied as an outermost coating. The layers were as follow: First layer: EVOH and Second layer: MMT, Tannic acid, bTPU, PCL, and CAB blends. The composition included PLA sheet, 10% EVOH, 30% MMT, 30% tannic acid, 10% bTPU, 10% CAB, 10% PCL, THF, ethanol, and water. Briefly, 10% EVOH solution was prepared in 3:1 concentration of ethanol and water. 30% MMT and 10% tannic acid, 10% PCL, 10% bTPU and 10% CAB solution was prepared in THF with constant stirring at low temperature. Solutions were coated onto the sheet and dried.

### EVOH/AKD/CAB

A three-layer coating with EVOH, AKD, and CAB was assessed. The layers were as follow: First layer: EVOH, Second layer: AKD wax Third layer: CAB. The composition included 10% EVOH, 100% AKD, 10% CAB, THF, ethanol, toluene, and water. 10% EVOH solution was prepared in 3:1 concentration of ethanol and water at constant stirring under high temperature. 100% AKD in was prepared toluene. 10% CAB was prepared in THF. The layers were coated individually on the bottle. It has a uniform and smooth coating.

### Silica/Beeswax/Soya Wax/Cellulose Acetate

A three-layer coating with Silica Nanoparticles+Bees Wax+Soya Wax and Cellulose Acetate was assessed. Bees Wax+Soya Wax and Cellulose Acetate are biodegradable polymers. It acts as an excellent permeability barrier. Cellulose Acetate is an excellent binder with other materials and is applied as an outermost coating with smooth outer surface. The layers were as follow: First layer—Silica Nanoparticles, Second layer—Bees Wax+Soya Wax Third layer—Cellulose Acetate. The composition included PLA sheet, 5% Silica Nanoparticles, 50% Bees Wax+50% Soya Wax, 5% Cellulose Acetate, and Acetone. 5% Silica Nanoparticles in Acetone were prepared separately then coated as the first layer. 50% of Soya and 50% of Bees wax were melted and coated as a second layer on the Silica Np coated sheet. Finally, a 5% Cellulose Acetate solution was coated as the final layer for the smooth surface. Excellent coating and very smooth surface.

### Silica/Cellulose Acetate

A Two-layer coating with Silica Nanoparticles and Cellulose Acetate was assessed. Cellulose Acetate is an excellent binder with other materials and is applied as an outermost coating with a smooth outer surface. Silica Nanoparticles help to improve barrier properties. The layers were the first layer—Silica Nanoparticles, Second layer—Cellulose Acetate. The composition included PLA sheet, 5% Silica Nanoparticles, 5% Cellulose Acetate, and Acetone. 5% Silica Nanoparticles in Acetone were prepared separately at constant stirring under temperature to dissolve completely then coated as the first layer. 5% Cellulose Acetate solution mixed separately with Acetone and constant stirring under temperature to dissolve completely then coated Cellulose Acetate solution as the final layer for the smooth surface. Excellent coating and very smooth surface.

### Silica/AKD

A Two-layer coating with Silica Nanoparticles and Alkyl Ketene Dimer (AKD) was assessed. Silica Nanoparticles help to improve barrier properties. Alkyl Ketene Dimer (AKD) is a compostable material and it is mainly used in paper making. This AKD wax coating can improve the moisture barrier. The layers were the first layer—Silica Nanoparticles, Second layer—Alkyl Ketene Dimer (AKD). The composition included PLA sheet, 5% Silica Nanoparticles, 20% Alkyl Ketene Dimer (AKD), toluene, and acetone. 5% Silica Nanoparticles in Acetone were prepared separately then coated as the first layer. 20% Alkyl Ketene Dimer (AKD) wax blend with Toluene was prepared separately and coated as the final layer for the smooth surface. Excellent coating and very smooth surface was achieved.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified.

It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

The foregoing description is illustrative of particular embodiments of the disclosure, but is not meant to be a limitation upon the practice thereof. The following claims, including all equivalents thereof, are intended to define the scope of the disclosure.

We claim:

1. A containment comprised of:
a biopolymer layer comprised of a biopolymer, wherein the biopolymer includes at least one of polyhydroxyalkanote (PHA), poly(3-hydroxybutyrate-co-3-hydroxyvalerate) (PHBV), polybutylene succinate (PBS), lignin, starch, polyhydroxybutyrate (PHB), PHBH (random copolymer of (R)-3-hydroxybutyrate and (R)-3-hydroxyhexanoate), polylactic acid (PLA), polybutylene adipate terephthalate (PBAT), PBST (polybutylene succinate-co-terephthalate), PBSA (polybutylene succinate-co-butylene adipate), polybutylene terephthalate (PBT), poly(vinyl) alcohol (PVA), poly(glycolic acid) (PGA), chitosan, polycaprolactone (PCL), and combinations thereof, and
a coating layer disposed on one or more surfaces of the biopolymer layer, the coating layer comprising at least one of silica nanoparticles, hydrophobic silica nanoparticles, beeswax, soya wax, cellulose, cellulose acetate, cellulose triacetate, carboxy methyl cellulose, montmorillonite (MMT), alkyl ketene dimer (AKD), AKD nanoparticles, AKD wax, poly(vinyl) alcohol (PVA), carnauba wax, palmityl chloride, polyvinyl palmitate chloride (PVPC), starch (soluble), starch nanoparticles, xylan, tapioca, palm root, tetraethyl orthosilicate (TEOS), zein, zein nanoparticles, glycerol, gelatin, sorbitol, ammonium zirconium carbonate (AZC), ethylene-vinyl alcohol copolymer (EVOH), polyhydroxy alkanotes (PHA), polydimethylsiloxane (PDMS), gelatin, sodium acetate, lignin, zinc oxide nanoparticles, copper (II) oxide nanoparticles, copper (I) oxide nanoparticles, magnesium oxide nanoparticles, nano clay nanoparticles, nano-starch nanoparticles, nano-cellulose nanoparticles, carbon nanotubes nanoparticles, carbon nanotube fiber nanoparticles, stearic acid, citric acid, glycerol, starch, HNTs, PDMS, soybean oil, zein, chitosan, nano clay, cellulose nanofibers, cellulose ester(s), PLA, and/or PCL and/or titanium dioxide nanoparticles.

2. The containment of claim 1, wherein the biopolymer layer comprises at least one of polyhydroxyalkanote (PHA), poly(3-hydroxybutyrate-co-3-hydroxyvalerate) (PHBV), polybutylene succinate (PBS), polylactic acid (PLA), polybutylene adipate terephthalate (PBAT), and PBSA (polybutylene succinate-co-butylene adipate).

3. The containment of claim 1, wherein the biopolymer layer comprises PLA and PHA.

4. The containment of claim 3, wherein the biopolymer layer comprises 20 to 80% by weight PLA and 20 to 80% by weight PHA.

5. The containment of claim 3, wherein the biopolymer layer further comprises one or more additives at up to 10% by weight of the biopolymer layer, the additives elected from one or more of a blowing additive, an antioxidant, an ethylene copolymer, an aliphatic-aromatic copolyester, a compactable additive, antioxidant, and a mold release agent.

6. The containment of claim 5, wherein the additives include one or more of erucamide and silica.

7. The containment of claim 5, wherein the biopolymer layer comprises 45 to 55 wt % PLA, 40 to 50 wt % PHA, and 3 to 10 wt % additives.

8. The containment of claim 2, wherein the coating layer comprises at least one of polycaprolactone (PCL), alkyl ketene dimer (AKD), AKD nanoparticles, AKD wax, poly(vinyl) alcohol (PVA), polydimethylsiloxane (PDMS), beeswax, carnauba wax, citric acid, and montmorillonite (MMT) nanoclay.

9. The containment of claim 3, wherein the coating layer comprises a first layer and a second layer, wherein the first layer is applied to the biopolymer layer and the second layer is applied to the first layer.

10. The containment of claim 9, wherein the first layer comprises 40 to 50 wt % PCL, 40 to 50 wt % AKD, and 5 to 15 wt % citric acid.

11. The containment of claim 10, wherein, the second layer comprises 85 to 95 wt % PCL and 5 to 15 wt % citric acid.

12. The containment of claim 9, wherein the first layer comprises 13 to 24 wt % beeswax, 28 to 38 wt % carnauba wax, 32 to 42 wt % PCL, and 6 to 16 wt % citric acid.

13. The containment of claim 12, wherein, the second layer comprises 85 to 95 wt % PCL and 5 to 15 wt % citric acid.

14. The containment of claim 3, wherein the coating layer comprises 46 to 56 wt % PCL, 35 to 45 wt % AKD, and 4 to 14 wt % citric acid.

15. The containment of claim 3, wherein the coating layer comprises 45 to 55 wt % PCL, 35 to 45 wt % AKD wax, and 5 to 15 wt % citric acid.

16. The containment of claim 3, wherein the coating layer comprises 11 to 21 wt % beeswax, 24 to 34 wt % carnauba wax, 40 to 50 wt % PCL, and 6 to 16 wt. % citric acid.

17. The containment of claim 3, wherein the coating layer comprises 14 to 24 wt % PVA, 3 to 11 wt % MMT, 29 to 39 wt % ADK wax emulsion, 29 to 39 wt % carnauba wax emulsion, and 2 to 8 wt % PDMS.

18. The containment of claim 3, wherein the coating layer comprises 15 to 25 wt % PVA, 3 to 11 wt % MMT, 31 to 41 wt % ADK wax emulsion, and 31 to 41 wt % carnauba wax emulsion.

19. The containment of claim 3, wherein the containment further comprises a cap comprising the biopolymer.

20. The containment of claim 19, wherein the cap further comprises the coating layer.
